(19) United States
(12) Patent Application Publication
(10) Pub. No.: US 2005/0063330 A1
(43) Pub. Date: Mar. 24, 2005

(54) Method for uplink bandwidth request and allocation based on a quality of service class in a broadband wireless access communication system

(75) Inventors: Sung-Jin Lee, Suwon-si (KR); Chang-Hol Koo, Seongnam-si (KR); Jung-Je Son, Seongnam-si (KR); Yeong-Moon Son, Anyang-si (KR); So-Hyun Kim, Suwon-si (KR); Hyun-Jeong Kang, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/945,460

(22) Filed: Sep. 20, 2004

(30) Foreign Application Priority Data
Sep. 20, 2003 (KR) 65423/2003

(51) Int. Cl. H04Q 7/00; H04J 1/16; H04J 3/16

(52) U.S. Cl. 370/328; 370/230; 370/468

(57) ABSTRACT

A bandwidth allocation method for an uplink data transmission between a mobile subscriber station and a base station in a broadband wireless access communication system. The method includes inserting type information of a service requested by the mobile subscriber station into the access channel signal and transmitting the access channel signal to the base station, receiving uplink scheduling information according to the type of the service requested by the mobile subscriber station from the base station, and transmitting data using a transmission bandwidth allocated according to the uplink scheduling information.

### PRIORITY

This application claims priority to an application entitled “Method For Uplink Bandwidth Request And Allocation Based On Quality Of Service Class In Broadband Wireless Access Communication System” filed in the Korean Intellectual Property Office on Sep. 20, 2003 and assigned Serial No. 2003-65423, the contents of which are incorporated herein by reference.

### BACKGROUND OF THE INVENTION

1. Field of the Invention

The present invention relates generally to a broadband wireless access communication system, and more particularly to a method for requesting and allocating an uplink bandwidth according to qualities of service (QoS) in a broadband wireless access communication system, which utilizes an orthogonal frequency division multiplexing (OFDM) scheme.

2. Description of the Related Art

A fourth generation (4G) communication system, which is a next generation communication system, is actively being designed and studied in order to provide users with multiple services having various QoS at a high transmission rate. Current third generation (3G) communication systems support a transmission speed of about 384 kbps in an outdoor channel environment having a relatively unfavorable channel environment and support a maximum transmission speed of 2 Mbps in an indoor channel environment having a relatively favorable channel environment.

Further, wireless local area networks (LAN) systems and wireless metropolitan area networks (MAN) systems generally support transmission speeds of 20 to 50 Mbps. Accordingly, in current 4G communication systems, research is actively being conducted to develop a new type of communication system for ensuring mobility and QoS in wireless LAN system and wireless MAN system, which support the relatively high transmission speeds and high speed services that are to be provided by the 4G communication system.

FIG. 1 illustrates a conventional broadband wireless access communication system. However, prior to describing FIG. 1, it is noted that a wireless MAN system is a type of broadband wireless access communication system capable of providing a wider service coverage area and a higher transmission speed than that of a wireless LAN system.

An IEEE (Institute of Electrical and Electronics Engineers) 802.16a communication system applies an OFDM scheme and an orthogonal frequency division multiple access (OFDMA) scheme to a physical channel of the wireless MAN system in order to support a broadband transmission network. Because the IEEE 802.16a communication system applies the OFDM/OFDMA scheme to the wireless MAN system, the IEEE 802.16a communication system transmits a physical channel signal using a plurality of sub-carriers, thereby making it possible to transmit high-speed data.

I An IEEE 802.16e communication system is achieved by supplementing the above-described IEEE 802.16a communication system to enable the mobility of a subscriber station (SS). However, currently, the IEEE 802.16e communication system has not been standardized in specific detail.

Further, both IEEE 802.16a and IEEE 802.16e communication systems are broadband wireless access communication systems using the OFDM/OFDMA scheme. For the convenience of explanation, however, only the IEEE 802.16a communication system will be described below as an example. The IEEE 802.16a and IEEE 802.16e communication systems can use either the OFDM/OFDMA scheme or a single carrier (SC) scheme, but the following description will be given in consideration of using only the OFDM/OFDMA scheme.

Referring to FIG. 1, the IEEE 802.16a communication system has a single cell structure and includes a base station (BS) 100 and a plurality of subscriber stations 110, 120, and 130, which are managed by the base station 100. The base station communicates with the subscriber stations 110, 120, and 130 using the OFDM/OFDMA scheme.

The wireless MAN system is suitable for high-speed communication services because it has a wide service coverage area and provides a high transmission speed. However, because the wireless MAN system does consider the user's mobility, that is the mobility of a subscriber station, handoffs are also not taken into consideration in the wireless MAN system. Therefore, it is necessary to develop a definite operation scheme of a medium access control (MAC) layer, which minimizes power consumption of a subscriber station moving at a high speed and supports an operation for a high-speed packet data transmission between the subscriber station and a base station.

Hereinafter, the operational states of the MAC layer previously proposed in the broadband wireless access communication system will be described. In a method of controlling the operational states of the MAC layer, support of the mobility of subscriber stations must be considered and the power consumption of the subscriber stations must be minimized. In the following description, a subscriber station having mobility is called a “mobile subscriber station” (MSS).

However, prior to describing the operational states of the MAC layer, newly proposed downlink channels and uplink channels for supporting the operational states of the MAC layer will be described. More specifically, the newly proposed downlink channels will be described first with reference to Table 1.

TABLE 1

| Name of Channel | Purpose of Transmission | Kind of Channel |
|---|---|---|
| Downlink Pilot | cell identification, | common channel |
| channel | synchronization acquisition | |
| (DL-PICH) | | |
| Downlink Broadcast | transmission of system | common channel |
| channel | information | |
| (DL-BCCH) | | |
| Downlink Traffic | burst traffic channel | share in a time-shared |
| channel | (burst traffic transmission) | scheme |
| (DL-TCH) | dedicated traffic channel | fixed allocation |
| | (fixed allocation) | |
| | signaling channel | dedicated channel |
| Downlink Traffic | transmission of control | common channel |
| control channel | information about DL-TCH | |
| (DL-TCCH) | | |

(1) Downlink Pilot Channel (DL-PICH)

The DL-PICH is a channel for cell identification and for the synchronization of a base station (BS) and a mobile subscriber station. The mobile subscriber station receives the DL-PICH signals transmitted from a plurality of base stations after being powered on, and determines which base station transmits a DL-PICH signal having the greatest carrier-to-interference-and-noise ratio (CINR) from among the received DL-PICH signals as the base station to which the mobile subscriber station belongs.

(2) Downlink Broadcast Channel (‘DL-BCCH’)

The DL-BCCH is a channel for transmitting the system configuration information related to the broadband wireless access communication system, neighbor cell information, the downlink and uplink channel configuration information, the downlink and uplink access information, and the paging information representing that there is a call to a particular mobile subscriber station. When the system configuration information, the downlink and uplink channel configuration information, the downlink and uplink access information, and the like are changed, the base station updates the changed information and periodically transmits the updated information to a mobile subscriber station through the DL-BCCH. In addition, a response to the uplink access is also transmitted through the DL-BCCH. The DL-BCCH is established as a super frame unit, and the information is periodically and repeatedly transmitted in a super frame unit. Herein the super frame includes a predetermined number of frames.

(3) Downlink Traffic Channel (‘DL-TCH’)

The DL-TCH is a channel for transmitting the actual packet data. According to the characteristics of packet data to be transmitted, three logical channels may be mapped to the DL-TCH as described below. The traffic channel is also included to uplink channels.

a. Burst Traffic Channel

The burst traffic channel is a logical channel for transmitting burst traffic, in which the burst traffic is transmitted in a time-shared scheme that provides a burst-based dynamic allocation scheme based on a dynamic scheduling scheme. Through the burst traffic channel, the real-time service (RTS) data is scheduled to be transmitted, the non-real-time service (NRTS) data is transmitted, or the best effort service data are transmitted.

b. Dedicated Traffic Channel

The dedicated traffic channel is a channel for allocating a fixed minimum bandwidth. Service data to which a minimum bandwidth is continuously allocated, such as unsolicited guaranteed service (UGS) data, is transmitted through the dedicated traffic channel.

c. Signaling Channel

The signaling channel is a channel for transmitting a signaling message, which is control information.

(4) Downlink Traffic Control Channel (‘DL-TCCH’)

The DL-TCCH is a channel for transmitting the control information for a mobile subscriber station to efficiently process the data transmitted through the DL-TCH, i.e., the control information related to the DL-TCH. The DL-TCCH is always transmitted in connection with the DL-TCH. The control information transmitted through the DL-TCH includes adaptive modulation and coding(‘AMC’) scheme information applied to the data transmitted through the DL-TCH, information used in the data decoding such as encoded packet size (EP) information, a MAC control message, etc.

Also, the base station may feedback the AMC scheme information related to the packet data, which is transmitted through an uplink, to the mobile subscriber station through the DL-TCCH.

The currently-proposed uplink channels are shown below in Table 2.

TABLE 2

| Name of | | |
|---|---|---|
| Channel | Purpose of transmission | Kind of Channel |
| Uplink Access | Uplink access of contention-based | common channel |
| Channel | scheme | |
| (UL-ACH) | Uplink access of contention-free | common channel |
| | scheme | |
| Uplink Traffic | Burst traffic channel | share in time-shared |
| Channel | | scheme |
| (UL-TCH) | Dedicated traffic channel | fixed allocation |
| | Signaling channel | dedicated channel |
| | (transmission of signaling | |
| | message) | |

(1) Uplink Access Channel (‘UL-ACH’)

The UL-ACH is a channel used by a mobile subscriber station in a bandwidth allocation request signal to request a bandwidth allocation, for the purpose of data transmission through an uplink, that is, for the purpose of uplink access. According to the grade of the mobile subscriber station or the characteristics of data to be transmitted through the uplink, two logical channels as described below may be mapped to the UL-ACH.

a. Access Channel

The access channel is a channel for uplink access of a contention-based scheme, and is used when the mobile subscriber station enters a network or when the mobile subscriber station requests a bandwidth allocation. Through the access channel, a very small amount of data, such as a TCP)(Transmission Control Protocol) ACK/NACK signal, may be transmitted together with an uplink access request signal (access preamble+packet data).

b. Fast Access Channel

The fast access channel is a channel for the uplink access of a contention-free scheme. An orthogonal code, such as a pseudorandom noise (PN) code, or a time slot position, which is used for the uplink access, is allocated to a mobile subscriber station from a base station. The mobile subscriber station performs the uplink access through the fast access channel using the orthogonal code or the time slot position allocated from the base station.

(2) Uplink Traffic Channel (‘UL-TCH’)

The UL-TCH is a channel used when a mobile subscriber station transmits data to a base station. According to the characteristics of the data transmitted through the UL-TCH, three logical channels may be mapped to the UL-TCH as described above. Herein, the traffic channel is also included to the downlink channels as described above.

a. Burst Traffic Channel

The burst traffic channel has the same function as that of the burst traffic channel mapped to the DL-TCH, and has only one difference in that the burst traffic channel is mapped not to the DL-TCH but to the UL-TCH.

b. Dedicated Traffic Channel

The dedicated traffic channel has the same function as that of the dedicated traffic channel mapped to the DL-TCH, and has only one difference in that the dedicated traffic channel is mapped not to the DL-TCH but in the UL-TCH.

c. Signaling Channel

The signaling channel has the same function as that of the signaling channel mapped to the DL-TCH, and has only one difference in that the signaling channel is mapped not to the DL-TCH but to the UL-TCH.

FIG. 2 is a state diagram illustrating operational states supported by a MAC layer in a broadband wireless access communication. More specifically, the proposed MAC layer of the broadband wireless access communication system supports five types of operational states, that is, a null state 211, an initialization state 213, a sleeping state 215, an access state 217, and a traffic state 219. The operational states of the proposed MAC layer minimizes the power consumption of the mobile subscriber station and supports operations between the mobile subscriber station and the base station for the transmission of fast packet data.

The null state 211 is used to perform an initial operation, when a mobile subscriber station is powered on, or when the mobile subscriber station is reset by an abnormal operation. It is possible that the state transition can be performed from each of the initialization state 213, the sleeping state 215, the access state 217, and the traffic state 219 into the null state 211. As described above, when the mobile subscriber station normally performs an initial operation following a reset or power-on of the mobile subscriber station, the mobile subscriber station transitions from the null state 211 into the initialization state 213.

In the initialization state 213, when having normally completed an initial operation following a reset or power-on, the mobile subscriber station performs a synchronization acquisition operation with a base station. In order to perform a synchronization acquisition operation with the base station, the mobile subscriber station monitors all frequency bands, which are predetermined in the mobile subscriber station, and detects a DL-PICH signal having the greatest intensity, that is, having the greatest CMNR. When the mobile subscriber station is handed off from a cell in which the mobile subscriber station itself exists, that is, from a prior base station, to a new cell, i.e., to a target base station, the mobile subscriber station also performs a synchronization acquisition operation with the target base station in the initialization state 213.

In an IEEE(Institute of Electrical and Electronics Engineers) 802.16a communication system, which is a typical broadband wireless access communication system, because the mobility of the mobile subscriber station is not considered, it is enough to consider only the case in which the mobile subscriber station is powered on or is reset. However, in a broadband wireless access communication system that considers the mobility of the mobile subscriber station, such as an IEEE 802.16e communication system, because the mobility of the mobile subscriber station is considered, the case in which the mobile subscriber station is powered on or is reset, and the case in which the mobile subscriber station is handed off must be considered. Therefore, the IEEE 802.16e communication system is constructed taking into consideration not only the case in which the mobile subscriber station is powered on or is reset, but also the case in which the mobile subscriber station is handed off. That is, the mobile subscriber station continuously monitors whether or not there is a second base station transmitting a DL-PICH signal having a greater CINR than that of a DL-PICH signal transmitted from a first base station to which the mobile subscriber station currently belongs, by considering a hand-off state.

Under a continuous monitoring operation, when there is a second base station which transmits a DL-PICH signal having a greater CINR than that of a DL-PICH signal transmitted from a first base station to which the mobile subscriber station currently belongs, the mobile subscriber station performs a cell reselection operation.

The mobile subscriber station, after synchronizing with the base station, receives a DL-BCCH signal transmitted from the base station to receive the system information (SI). Thereafter, the mobile subscriber station performs a network entry operation for the registration and the authentication to the base station to perform an operation for transmitting/receiving normal packet data to/from the base station, and then transitions into the sleeping state 215, the access state 217, or the traffic state 219.

The system information includes system configuration information, neighbor base station information, downlink and uplink channel configuration information, and downlink and uplink access information as described with reference to Table 1.

In the initialization state 213, when the mobile subscriber station loses its synchronization with the base station due to a problem, such as a system error, the mobile subscriber station transitions from the initialization state 213 into the null state 211, thereby performing an initial operation again. That is, when the mobile subscriber station is reset due to a problem, such as a system error, it is necessary that the mobile subscriber station starts its operation in the null state 211. The mobile subscriber station also transitions from the initialization state 213 into the traffic state 219 when the mobile subscriber station receives paging information indicating that there is data transmitted from the mobile subscriber station to the base station, after performing a network entry operation for the registration and the authentication to the base station.

The operation of a mobile subscriber station in the initialization state 213 will be simplified as follows.

(1) DL-PICH signal monitoring and synchronization acquisition with the base station.

(2) DL-BCCH signal monitoring operation: Receiving system configuration information, neighbor base station information, downlink and uplink channel configuration information, downlink and uplink access information, and paging information representing that there is a call to a mobile subscriber station, etc.

(3) Network entry operation for the registration and the authentication to the base station.

In the network entry operation, the mobile subscriber station uses the UL-ACH when performing an uplink access to a base station. A response signal to the uplink access, which relates to a network entry operation and is performed through the UL-ACH, is received through the DL-BCCH.

The mobile subscriber station transitions from the initialization state 213 into the sleeping state 215 when the mobile subscriber station has no data to be transmitted/received to/from a base station, after performing a network entry operation in the initialization state 213. That is, after the mobile subscriber station performs a network entry operation in the initialization state 213, if there are no data to be transmitted/received between the mobile subscriber station and the base station, the mobile subscriber station transitions into the sleeping state 215 so as to minimize power consumption.

Further, while monitoring the DL-BCCH in the sleeping state 215, if the mobile subscriber station receives information representing that there is a paging to be received by the mobile subscriber station, the mobile subscriber station transitions from the sleeping state 215 into the traffic state 219, to receive the data from the base station. In the sleeping state 215, when the mobile subscriber station loses its synchronization with the base station due to a problem, such as a system error, the mobile subscriber station transitions from the sleeping state 215 into the null state 211, thereby performing an initial operation again. That is, when the mobile subscriber station is reset due to a problem, such as a system error, it is necessary that the mobile subscriber station restart its operation in the null state 211.

The mobile subscriber station transitions from the initialization state 213 into the access state 217 when the mobile subscriber station has data to be transmitted/received to/from a base station, after performing a network entry operation in the initialization state 213. That is, after the mobile subscriber station performs a network entry operation in the initialization state 213, if there is data to be transmitted/received between the mobile subscriber station and the base station, the mobile subscriber station transitions into the access state 217 in order to access the base station. In the access state 217, the mobile subscriber station performs an access operation to the base station.

The access to the base station, which is performed in the access state 217, is basically carried out in a contention-based scheme. The mobile subscriber station requests bandwidth allocation to the base station in order to transmit data, that is, traffic to the base station. The access to a base station (i.e., uplink access) of a contention-based scheme is performed using the UL-ACH. According to a bandwidth allocation request of the mobile subscriber station, the base station allocates a bandwidth to be used by the mobile subscriber station into the mobile subscriber station when there is a currently available bandwidth, and notifies the mobile subscriber station of the allocated bandwidth information.

The mobile subscriber station, which has determined that the bandwidth is allocated, transitions from the access state 217 into the traffic state 219. However, when the mobile subscriber station does not receive a bandwidth allocation from the base station in spite of the request of bandwidth, that is, when the mobile subscriber station fails to access the base station, the mobile subscriber station transitions from the access state 217 to the sleeping state 215.

When the allocation of bandwidth fails, the mobile subscriber station may again request a bandwidth allocation, and the mobile subscriber station transitions from the access state 217 into the sleeping state 215 when the bandwidth allocation is not accomplished during a predetermined period of time. When the mobile subscriber station cancels the data transmission, and when the mobile subscriber station fails to access the base station, the mobile subscriber station transitions from the access state 217 to the sleeping state 215.

While the mobile subscriber station is performing the uplink access in the access state 217, if the mobile subscriber station loses synchronization with the base station due to a problem, such as a system error, the mobile subscriber station transitions from the access state 217 into the null state 211, thereby performing an initial operation again. That is, when the mobile subscriber station is reset due to a problem, such as a system error, it is necessary that the mobile subscriber station restart its operation in the null state 211.

In the traffic state 219, the mobile subscriber station transmits/receives data to/from the base station. Also, in the traffic state 219, although the mobile subscriber station does not directly transmit/receive actual data to/from the base station, the mobile subscriber station is allocated resources for a later transmission/reception of data. That is, in the traffic state 219, because resources have been allocated for the transmission/reception of the data although there is no actual data to be transmitted/received between the mobile subscriber station and the base station, the mobile subscriber station can rapidly access the base station when data to be transmitted/received is generated, and the data can be normally transmitted/received.

In the traffic state 219, when there is no data to be transmitted/received between the mobile subscriber station and the base station, or when the power consumption of the mobile subscriber station must be reduced, the mobile subscriber station transitions from the traffic state 219 to the sleeping state 215. Also, in the traffic state 219, when the mobile subscriber station loses synchronization with the base station due to a problem, such as a system error, the mobile subscriber station transitions from the traffic state 219 into the null state 211, thereby performing an initial operation again.

When the mobile subscriber station is reset due to a problem, such as a system error, it is necessary for the mobile subscriber station restart its operation in the null state 211.

FIG. 3 is a view schematically illustrating operation modes of the initialization state 213 illustrated in FIG. 2. Referring to FIG. 3, the initialization state 213 includes two operation modes, that is, a system detecting mode 300 and a network entry mode 350. As described with reference to FIG. 2, when the mobile subscriber station normally performs an initial operation following a reset of power-on, the mobile subscriber station transitions from the null state 211 into the initialization state 213 in step 311. The mobile subscriber station loses synchronization with the base station due to a problem, such as a system error, in the initialization state 213, the mobile subscriber station transitions from the initialization state 213 into the null state 211, thereby performing an initial operation again in step 313.

When the mobile subscriber station transitions from the null state 211 into the initialization state 213, the mobile subscriber station enters the system detecting mode 300 of the initialization state 213.

In the system detecting mode 300, the mobile subscriber station receives DL-PICH signals transmitted from a plurality of base stations, and detects a DL-PICH signal having the greatest CINR. In this state, when the mobile subscriber station is handed off from a prior base station, to which the mobile subscriber station had belonged, to a target base station, the mobile subscriber station also performs a synchronization acquisition operation with the target base station. Because the mobile subscriber station has to consider a hand-off state, the mobile subscriber station must continuously monitor whether or not there is a second base station which transmits a DL-PICH signal having a greater CINR than that of a DL-PICH signal transmitted from a first base station, to which the mobile subscriber station currently beings. Under such a continuous monitoring operation, when there is a second base station transmitting a DL-PICH signal having a greater CINR than that of a DL-PICH signal transmitted from a first base station to which the mobile subscriber station currently beings, the mobile subscriber station performs a cell reselection operation.

When detecting a DL-PICH signal having the greatest CINR as described above, the mobile subscriber station designates a base station transmitting the detected DL-PICH signal to be a base station to which the mobile subscriber station belongs, that is, as a serving base station, and receives a DL-BCCH signal transmitted from the serving base station. The mobile subscriber station receives the DL-BCCH signal to detect system configuration information, neighbor base station information, downlink and uplink channel configuration information, downlink and uplink access information, etc. When the mobile subscriber station normally performs the operation required in the system detecting mode 300, that is, the synchronization acquisition operation with the base station, the mobile subscriber station performs a mode change from the system detecting mode 300 into the network entry mode 350 in order to perform a network entry operation for transmitting/receiving data to/from the base station in step 315.

In the network entry mode 350, the mobile subscriber station performs an initial uplink access operation for network entry using uplink access information received in the system detecting mode 300. Herein, the initial uplink access operation for network entry is performed in a contention-based method, the mobile subscriber station performs the initial uplink access operation through an UL-ACH, and the base station transmits a response to the initial uplink access to the mobile subscriber station.

After the mobile subscriber station performs a network entry operation in the network entry mode 350, the mobile subscriber station transitions into the access state 217 if there is data to be transmitted to the base station in step 319. Also, after the mobile subscriber station performs a network entry operation in the network entry mode 350, the mobile subscriber station transitions into the traffic state 219, if the mobile subscriber station receives paging information, which represents that there is data to be transmitted to the mobile subscriber station through a DL-BCCH, in step 321.

Further, when the mobile subscriber station has no data to be transmitted/received to/from the base station in the network entry mode 350, the mobile subscriber station transitions into the sleeping state 215 in step 323. Finally, in the network entry mode 350, when the mobile subscriber station does not perform a normal operation due to a system error and the like, the mobile subscriber station changes into the system detecting mode 300 and must again perform an initial operation following a reset.

FIG. 4 is a view schematically illustrating operation modes of the sleeping state 215 illustrated in FIG. 2. Referring to FIG. 4, the sleeping state 215 includes two operation modes, that is, a sleeping mode 400 and an awake mode 450. As described with reference to FIG. 2, when the mobile subscriber station normally performs a network entry operation, the mobile subscriber station transitions from the initialization state 213 into the sleeping state 215 in step 411. The mobile subscriber station loses synchronization with the base station due to a problem, such as a system error, in the sleeping state 215, the mobile subscriber station transitions from the sleeping state 215 into the null state 211, thereby performing an initial operation again in step 413.

When the mobile subscriber station transitions from the initialization state 213 into the sleeping state 215, the mobile subscriber station enters the sleeping mode 400 or the awake mode 450 in the sleeping state 215. In the sleeping mode 400, when there is no data transmitted to the mobile subscriber station, the mobile subscriber station does not perform a demodulation operation of a receiving signal in order to reduce power consumption, and wakes for a predetermined listening interval to monitor a DL-BCCH transmitted from the base station. The mobile subscriber station can perform a mode change from the sleeping mode 400 into the awake mode 450 according to a predetermined control in step 415.

In the awake mode 450, the mobile subscriber station monitors a DL-BCCH transmitted from the base station. As described above, because the base station wakes up the mobile subscriber station in order to update system information or to transmit paging information for notifying the mobile subscriber station of data to be transmitted to the mobile subscriber station, the mobile subscriber station monitors the DL-BCCH and may check whether or not system information is undated and whether or not paging information is received to the mobile subscriber station.

Thereafter, when system information is updated, the mobile subscriber station confirms the updated system information and performs a mode change from the awake mode 450 into the sleeping mode 400 in step 417. Also, as a result of the monitoring of the DL-BCCH, when there is paging information to targets the mobile subscriber station, the mobile subscriber station transitions from the awake mode 450 into the traffic state 219 in step 425.

When the mobile subscriber station has data to be transmitted to the base station, the mobile subscriber station transitions from the awake mode 450 into the access state 217, thereby performing uplink access of a contention-based method. Also, when the mobile subscriber station fails in uplink access in spite of performing uplink access of a contention-based method during a predetermined period of time in the access state 217, the mobile subscriber station transitions from the access state 217 into the sleeping state 215 in step 421.

When the mobile subscriber station cancels the data transmission as well as when the mobile subscriber station fails in uplink access, the mobile subscriber station transitions from the access state 217 into the sleeping state 215. I

In the traffic state 219, when the mobile subscriber station has no data to be transmitted to the base station, or when the power consumption of the mobile subscriber station must be reduced, the mobile subscriber station transitions from the traffic state 219 into the sleeping state 215 in step 423.

FIG. 5 is a flowchart illustrating a signal transmitting/receiving process performed between a base station and a mobile subscriber station in the initialization state 213 illustrated in FIG. 2. Referring to FIG. 5, when the mobile subscriber station is powered on in step 511, the mobile subscriber station performs an initial operation in the null state 211. When normally completing the initial operation, the mobile subscriber station transitions into the system detecting mode 300 of the initialization state 213. In the system detecting mode 300, the mobile subscriber station receives a pilot signal through a DL-PICH which is transmitted from the base station in step 513, and receives system configuration information, neighbor base station information, downlink and uplink channel configuration information, downlink and uplink access information, etc., through a DL-BCCH in step 515.

The mobile subscriber station synchronizes with the base station using the DL-PICH transmitted from the base station in the system detecting mode 300, and then transit to the network entry mode 350. The mobile subscriber station transmits a network entry request message for network entry through an UL-ACH, which corresponds to uplink access information received through the DL-BCCH in the network entry mode 350 in step 517. When sensing a network entry request of the mobile subscriber station, the base station transmits a network entry response message through a DL-BCCH in response to the network entry request message of the mobile subscriber station in step 519.

Conventional wireless mobile communication is generally used to provide-voice service, but current wireless mobile communication is used to provide voice service and also various data packet services. Therefore, it is necessary to determine an uplink access procedure and a bandwidth allocation method according to the various packet data services in the above-described broadband wireless communication system.

With various requests in service schemes, a method for providing communication access services determined according to QoS is required in a broadband wireless access communication system. However, the current broadband wireless access communication system has proved inefficient to transmit various packet-based data through access services determined according to QoS as described above from the viewpoint of channel management and bandwidth allocation.

### SUMMARY OF THE INVENTION

Accordingly, the present invention has been designed to solve the above and other problems occurring in the prior art. An object of the present invention is to provide an uplink access method for a mobile subscriber station utilizing a packet data service in a broadband wireless access communication system.

Another object of the present invention is to provide a bandwidth allocation method for a packet data service in a broadband wireless access communication system.

Still another object of the present invention is to provide a communication access service for a packet data service in a broadband wireless access communication system.

To accomplish the above and objects, in accordance with one aspect of the present invention, there is provided a method of receiving a transmission bandwidth for data to be transmitted by a mobile subscriber station according to types of services requested by the mobile subscriber station in the mobile subscriber station in a broadband wireless access communication system in which a plurality of mobile subscriber stations request bandwidth allocation to a base station through a predetermined access channel signal. The method includes the steps of: inserting type information of a service requested by the mobile subscriber station into the access channel signal; transmitting the access channel signal to the base station; receiving uplink scheduling information according to the type of the service requested by the mobile subscriber station from the base station; and transmitting data using a transmission bandwidth allocated according to the uplink scheduling information.

In accordance with another aspect of the present invention, there is provided a method of receiving a transmission bandwidth for data to be transmitted by a mobile subscriber station according to types of services requested by the mobile subscriber station in a broadband wireless access communication system in which a plurality of mobile subscriber stations request bandwidth allocation to a base station through a predetermined access channel signal. The method includes the steps of: inserting information of representing that the type of the service requested by the mobile subscriber station is the unsolicited guaranteed service in the access channel signal; transmitting the access channel signal to the base station; receiving a response signal to the transmitted access channel signal from the base station; and transmitting data using an allocated transmission bandwidth when the transmission bandwidth requested by the mobile subscriber station is allocated through the response signal.

In accordance with still another aspect of the present invention, there is provided a method of receiving a transmission bandwidth for data to be transmitted by a mobile subscriber station according to types of services requested by the mobile subscriber station in a broadband wireless access communication system in which a plurality of mobile subscriber stations request bandwidth allocation to a base station through a predetermined access channel signal. The method includes the steps of: inserting information of representing that the type of the service requested by the mobile subscriber station is the realtime packet service in the access channel signal; transmitting the access channel signal to the base station; receiving a response signal to the transmitted access channel signal from the base station; making up a bandwidth request message when the response signal includes an dedicated orthogonal code; transmitting the made-up bandwidth request message to the base station through the dedicated orthogonal code; receiving a requested transmission bandwidth allocated from the base station; and transmitting data through the allocated transmission bandwidth.

In accordance with still another aspect of the present invention, there is provided a method of receiving a transmission bandwidth for data to be transmitted by a mobile subscriber station according to types of services requested by the mobile subscriber station in a broadband wireless access communication system in which a plurality of mobile subscriber stations request bandwidth allocation to a base station through a predetermined access channel signal. The method includes the steps of: inserting information of representing that the type of the service requested by the mobile subscriber station is the non-realtime packet service in the access channel signal; transmitting the access channel signal to the base station; receiving a response signal to the transmitted access channel signal from the base station; creating a bandwidth request message when the response signal includes an dedicated orthogonal code; transmitting the bandwidth request message to the base station through the dedicated orthogonal code; receiving a requested transmission bandwidth allocated from the base station; and transmitting data through the allocated transmission bandwidth.

In accordance with still another aspect of the present invention, there is provided a method of receiving a transmission bandwidth for data to be transmitted by a mobile subscriber station according to types of services requested by the mobile subscriber station in a broadband wireless access communication system in which a plurality of mobile subscriber stations request bandwidth allocation to a base station through a predetermined access channel signal. The method includes the steps of: inserting information indicating that the type of service requested by the mobile subscriber station is a non-realtime packet service in the access channel signal; transmitting the access channel signal to the base station; receiving bandwidth allocation information from the base station; and transmitting data using the transmission bandwidth allocated from the base station.

### BRIEF DESCRIPTION OF THE DRAWINGS

The above and other objects, features, and advantages of the present invention will be more apparent from the following detailed description taken in conjunction with the accompanying drawings, in which:

FIG. 1 illustrates a conventional broadband wireless access communication system;

FIG. 2 is a state diagram illustrating operational states supported by a_MAC layer in a broadband wireless access communication.;

FIG. 3 is a view schematically illustrating operation modes of the initialization state illustrated in FIG. 2;

FIG. 4 is a view schematically illustrating operation modes of the sleeping state illustrated in FIG. 2;

FIG. 5 is a flowchart illustrating a signal transmitting/receiving process performed between a base station and a mobile subscriber station in the initialization state illustrated in FIG. 2;

FIGS. 6A to 6D are flowcharts illustrating bandwidth request procedures according to qualities of service (QoS) in a broadband wireless access communication system according to embodiments of the present invention;

FIG. 7 is a flowchart illustrating a message transmission/reception procedure for a UGS between a base station and a mobile subscriber station according to an embodiment of the present invention;

FIG. 8 is a flowchart illustrating a message transmission/reception procedure for a realtime packet service between a base station and a mobile subscriber station according to an embodiment of the present invention;

FIG. 9 is a flowchart illustrating a message transmission/reception procedure for a non-realtime packet service between a base station and a mobile subscriber station according to an embodiment of the present invention;

FIG. 10 is a flowchart illustrating a message transmission/reception procedure for a best effort service between a base station and a mobile subscriber station according to an embodiment of the present invention;

FIGS. 11A to 11D are flowcharts, each of which illustrates the operation of a mobile subscriber station for requesting services according to qualities of service (QoS) according to embodiments of the present invention; and

FIGS. 12A to 12D are flowcharts, each of which illustrates the operation of a base station for requesting services according to qualities of service (QoS) according to embodiments of the present invention.

### DETAILED DESCRIPTION OF THE PREFERRED EMBODIMENT

Preferred embodiments of the present invention, i.e., methods for uplink bandwidth request and allocation based on QoS classes in a broadband wireless access communication system, will be described with reference to the accompanying drawings. In the following description of the present invention, a detailed description of known functions and configurations incorporated herein will be omitted when it may obscure the subject matter of the present invention.

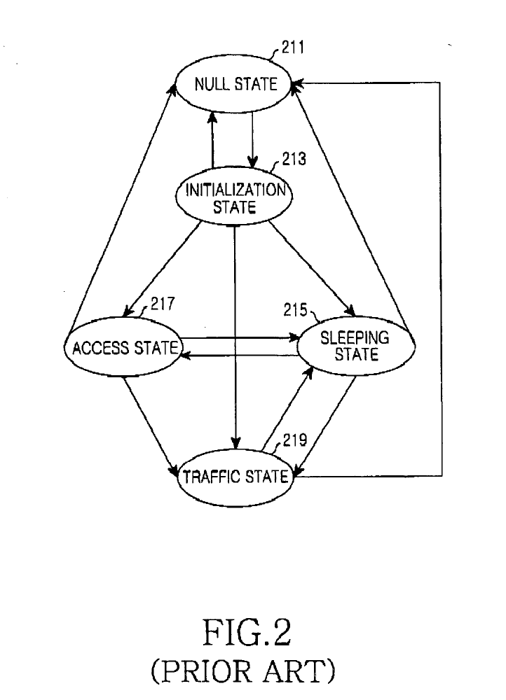

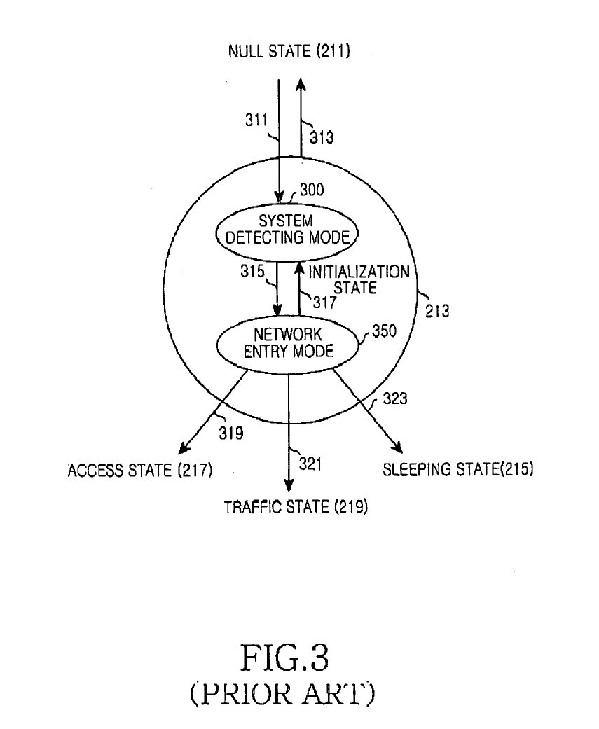

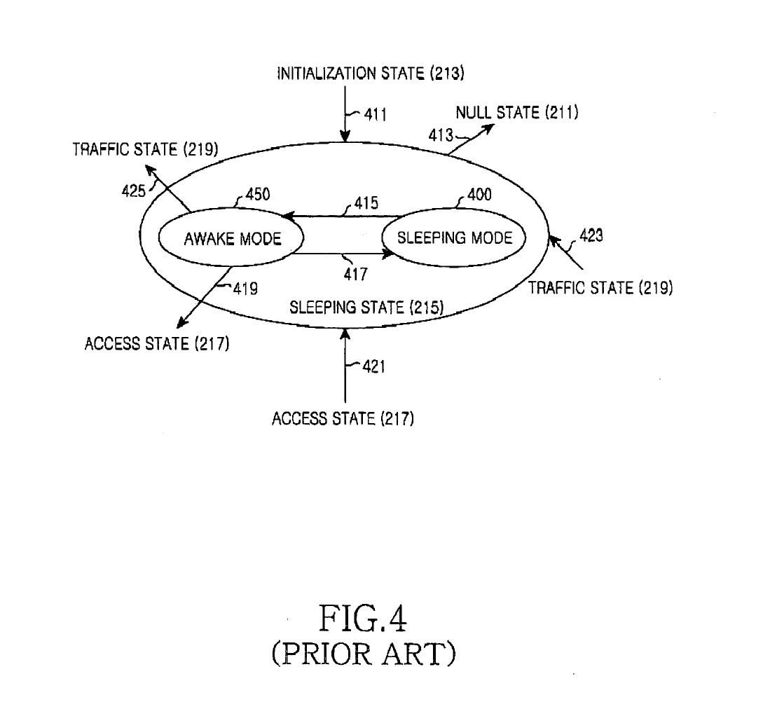

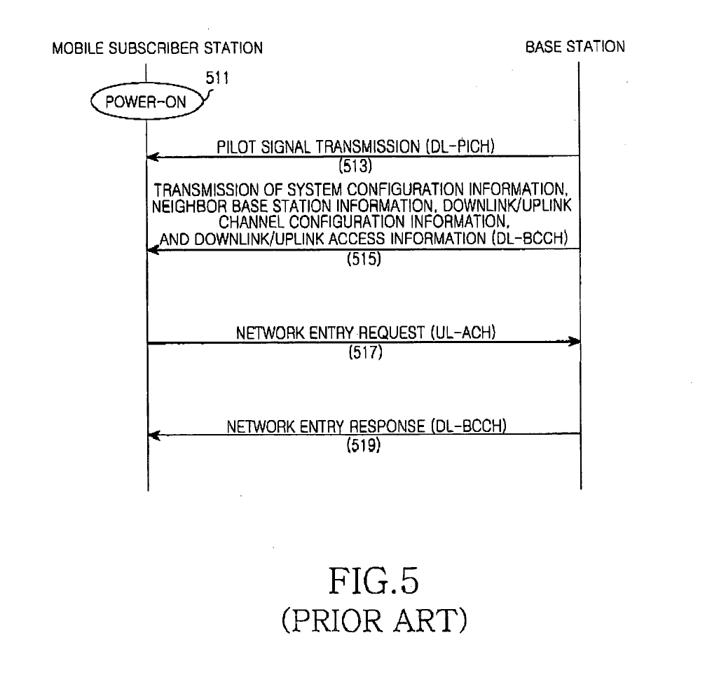

The present invention proposes uplink access methods according to types of requested service in a broadband wireless access communication system when a mobile subscriber station requests bandwidth allocation to a base station in order to transmit data through an uplink. That is, in an access state or a sleeping state as described with reference to FIG. 2, when data to be transmitted from the mobile subscriber station to the base station is generated and thus, the mobile subscriber station desires to enter a traffic mode, the mobile subscriber station must request bandwidth allocation for transmitting the generated data to the base station. In this case, according to the uplink access methods of the present invention, access methods for the bandwidth allocation request are adaptively realized according to types of service of data to be transmitted.

However, prior to describing the access methods according to each service in accordance with the present invention, service classes classified according to QoS considered in the present invention will be described with reference to Table 3 below.

TABLE 3

| Service of | |
|---|---|
| Class | |
| (QoS) | Description |
| UGS | Service which needs the same bandwidth to be continuously |
| | allocated while maintaining a connection such as a VoIP |
| | (Voice over Internet Protocol), a realtime voice transmission |
| | service |
| Realtime | Has the characteristics of a realtime service like an UGS, but |
| Service | causes variable bandwidth allocation because the amount of |
| | generated data is different depending on the frames, and |
| | conforms to video transmission |
| Non | Data service having no realtime service characteristics, does |
| Realtime | not have a burst characteristic as opposed to the best effort |
| Service | service, and conforms to an FTP (File Transfer Protocol) |
| Best | Service having a burst characteristic, conforms to WEB |
| Effort | services and the like, service of the lowest class, has an |
| Service | allocation of bandwidth in a non-assured form, allocates |
| | bandwidth only for each request |

(1) Unsolicited Guaranteed Service (UGS): The UGS is very sensitive to time delay in data transmission. Therefore, it is necessary for the base station to assure uplink bandwidth allocation to the mobile subscriber station. The UGS includes a packet-based voice phone service using the VoIP technique. In the voice phone service, a fixed amount of voice data is generated at every constant period of time.

In order to transmit a fixed amount of data generated at every constant period of time as describe above, the base station must repeatedly and continuously allocates a bandwidth suitable for the amount of data to the mobile subscriber station at every pre-engaged period of time while a connection is being maintained. Additionally, an allocation period and a size of an uplink bandwidth are determined by negotiations between the base station and the mobile subscriber station when an initial connection is established. Therefore, once a connection is established after the negotiations are finished, the base station must continuously assure bandwidth allocation until the connection is released, although the mobile subscriber station does not additionally request the bandwidth allocation.

(2) Realtime Packet Service (rtPS): The realtime packet service is a service for providing bandwidth allocation in realtime, which is also very sensitive to time delay in data transmission. Therefore, it is necessary for the base station to assure uplink bandwidth allocation to the mobile subscriber station. The realtime packet service is prior to a non-realtime packet service, which will be described later, in allocation and transmission of a bandwidth.

In the realtime packet service, the base station assures uplink bandwidth allocation to the mobile subscriber station at every fixed period of time. However, because the realtime packet service conforms to a video data (e.g., a video stream) transmission service, the realtime packet service does not provide fixed-size bandwidth allocation, unlike the above-mentioned UGS.

As a result, in the realtime packet service, while the base station periodically assures uplink bandwidth allocation to the mobile subscriber station, the mobile subscriber station informs the base station of a size of bandwidth to be actually allocated at every predetermined period of time. Therefore, in the realtime packet service, a method for continuously informing the base station the size of a required uplink bandwidth while a connection is being maintained between the base station and the mobile subscriber station must be provided, unlike the UGS.

(3) Non-realtime Packet Service (nrtPS): The non-realtime packet service, unlike the realtime packet service, is not provided in realtime, such that the non-realtime packet service is not sensitive to time delay in data transmission unlike the realtime packet service. For example, applications, such as a file transfer protocol (FTR), correspond to the non-realtime packet service. While a connection is being maintained, the mobile subscriber station transmits a bandwidth request message to the base station at all times, and then the base station allocates a bandwidth of a requested size to the mobile subscriber station.

The non-realtime packet service has the same characteristics as those of the best effort service, which will be described later. However, in the best effort service, a request message is transmitted to the base station through a contention-based access with other mobile subscriber stations, such that transmission delay may occur in a request message transmission step. In contrast, in the non-realtime packet service, the mobile subscriber station transmits a request message to the base station in a contention-free scheme, which does not contend with other mobile subscriber stations, such that request message transmission is not delayed and the reliable transmission of a request message can be guaranteed.

(4) Best Effort Service: The best effort service is a non-realtime service, which is not sensitive to time delay in data transmission. In the best effort service, while a connection is being maintained, the transmission of data is not continuously performed and has a burst characteristic. Therefore, the mobile subscriber station requests a required uplink bandwidth to the base station whenever data to be transmitted through an upper application is generated, and transmits the data using a bandwidth allocated from the base station.

In the best effort service, the mobile subscriber station transmits a request message to the base station on the basis of contention with other mobile subscriber stations, and the base station, having received the request message, allocates a bandwidth through uplink scheduling and notifies the mobile subscriber station of an available bandwidth size and a time point at which the relevant mobile subscriber station can transmit data through an uplink. Because the best effort service has the QoS of the lowest priority, the base station does not assure bandwidth allocation and service access of the best effort service.

Hereinafter, methods in which a mobile subscriber station accesses a base station and is allocated a bandwidth from the base station will be described according to the above-described types of services. However, prior to the description of the access method, various channels for access according to the types of services proposed in the present invention will be explained.

As described with reference to Tables 1 and 2, downlink channels include physical channels, which include a downlink pilot channel (DL-PICH), a downlink broadcast channel (DL-BCH), a downlink traffic channel (DL-TCH), and a downlink traffic control channel (DL-TCCH). Additionally, uplink channels include physical channels, which include an uplink access channel (UL-ACH) and an uplink traffic channel (UL-TCH).

The UL-TCH may include multiple physical channels, that is, an uplink burst traffic channel (UL-BTCH), which is time-shared to be used by a plurality of mobile subscriber stations, an uplink dedicated traffic channel (UL-DTCH), which is fixedly allocated to a single mobile subscriber station, and an uplink signaling traffic channel, which is dedicatedly used to transmit a signaling message.

Similarly to the UL-TCH, the DL-TCH may include multiple physical channels, that is, a downlink burst traffic channel (DL-BTCH), which is time-shared to be used by a plurality of mobile subscriber stations, a downlink dedicated traffic channel (DL-DTCH), which is fixedly allocated to a single mobile subscriber station, and a downlink signaling traffic channel, which is dedicatedly used to transmit a signaling message.

The UL-ACH may include a logical access channel (UL-ACCH), which is a logical channel for performing an uplink access in a contention-based scheme, and an uplink fast access channel (UL-FACCH), which is a logical channel for performing an uplink access in a contention-free scheme after a dedicated code or a dedicated time slot is allocated.

In addition, the present invention proposes a downlink-uplink scheduling channel (DL-USCCH). which is transmitted from a base station that has received an access channel signal described above, to a relevant mobile subscriber station as a response signal to the received access channel signal in order to allocate a requested bandwidth to the relevant mobile subscriber station. That is, according to the present invention, the base station transmits the DL-USCCH to the relevant mobile subscriber station in order to transmit bandwidth information allocated according to a bandwidth allocation request on the basis of the various types of services. In this case, the DL-USCCH includes bandwidth allocation information of a dedicated channel or a burst channel according to service classes requested by mobile subscriber stations.

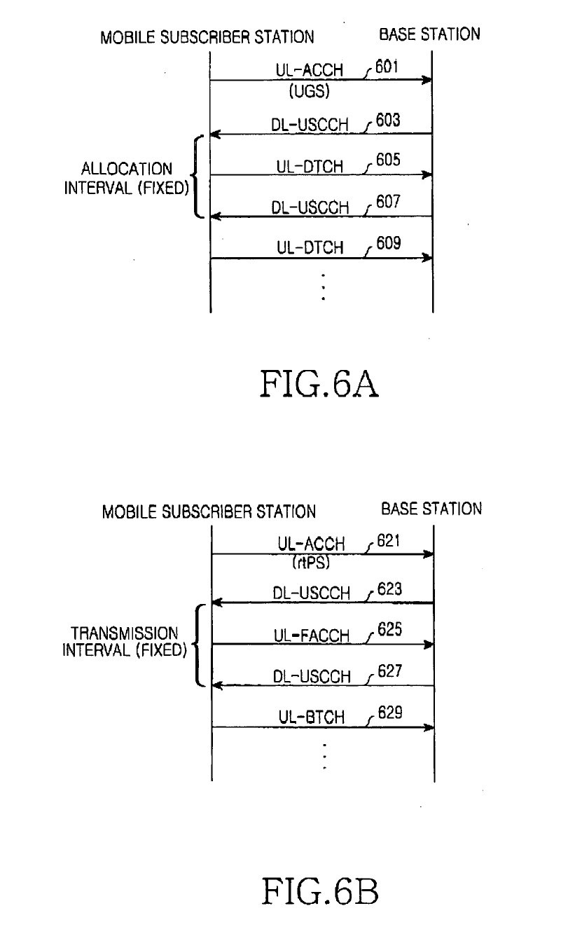

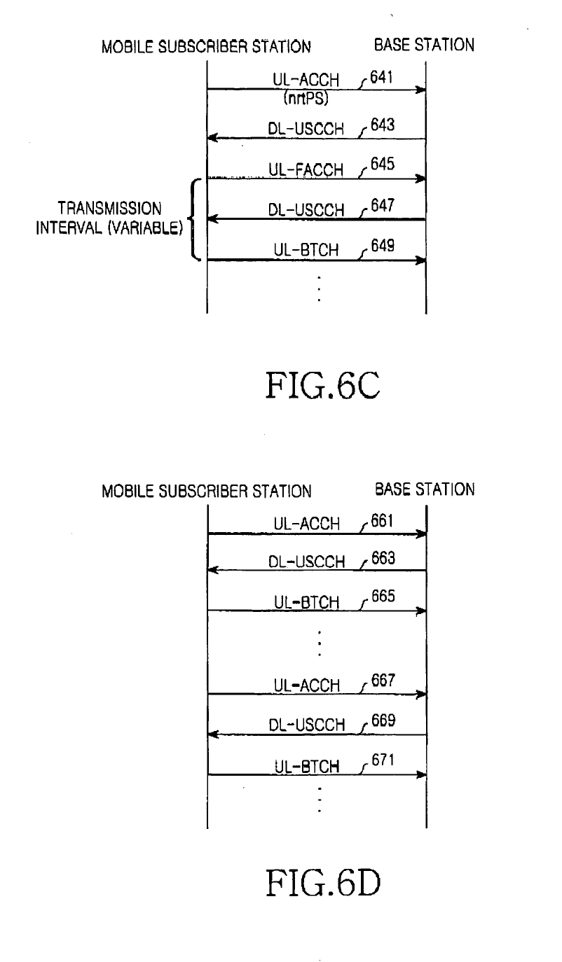

FIG. 6A is a flowchart illustrating a signal flow procedure between a mobile subscriber station and a base station when the mobile subscriber station requests a UGC service from the base station in a broadband wireless access communication system according to an embodiment of the present invention. Referring to FIG. 6A, the mobile subscriber station requests bandwidth allocation for the UGS to the base station by transmitting the UL-ACCH signal to the base station in step 601. The transmitted UL-ACCH signal includes information indicating that a service required by the mobile subscriber station through the bandwidth allocation request is a UGS, and thus the base station having received the UL-ACCH signal from the mobile subscriber station reads service class information included in the UL-ACCH signal and recognizes that the mobile subscriber station requests the UGS.

The base station allocates a dedicated bandwidth for the UGS to the mobile subscriber station by transmitting a DL-USCCH signal to the mobile subscriber station in step 603. When the mobile subscriber station receives the DL-USCCH signal, the mobile subscriber station confirms bandwidth allocation information included in the DL-USCCH and transmits data for the UGS through the allocated bandwidth. Because the mobile subscriber station requests the UGS, the dedicated channel is allocated as described above, and the mobile subscriber station transmits data, which is desired to be transmitted, through an allocated dedicated channel, i.e., through an UL-DTCH signal in step 605.

Because the UGS is a service in which the same bandwidth is fixedly and continuously allocated to a relevant mobile subscriber station, the dedicated channel must be allocated at every predetermined fixed allocation period of time. That is, because the predetermined fixed allocation period of time elapses, the base station transmits allocation information of a dedicated channel having the same size to the relevant mobile subscriber station through a new DL-USCCH signal in step 607. The mobile subscriber station having been allocated the dedicated channel, as described above, transmits an UL-DTCH signal to the base station according to the dedicated channel information included in the received DL-USCCH signal in step 609.

Because a service requested by the mobile subscriber station is a UGS, the base station transmits the DL-USCCH signal to the relevant mobile subscriber station at every predetermined fixed allocation period of time, thereby assuring that the mobile subscriber station is continuously provided with the UGS. Also, once the mobile subscriber station requests a UGS through the UL-ACCH signal, the base station continuously allocates a dedicated channel through the DL-USCCH signal, such that the mobile subscriber station can be continuously provided with the UGS through the allocated dedicated channel.

FIG. 6B is a flowchart illustrating a signal flow procedure between a mobile subscriber station and a base station when the mobile subscriber station requests a realtime packet service (rtPS) from the base station in a broadband wireless access communication system according to an embodiment of the present invention. Referring to FIG. 6B, the mobile subscriber station requests bandwidth allocation for the realtime packet service to the base station by transmitting the UL-ACCH signal to the base station in step 621. The transmitted UL-ACCH signal includes information indicating that a service required by the mobile subscriber station through the bandwidth allocation request is a realtime packet service. The base station receives the UL-ACCH signal from the mobile subscriber station, reads service class information included in the UL-ACCH signal, and recognizes that the mobile subscriber station requests the realtime packet service.

The base station transmits a DL-USCCH signal to the mobile subscriber station in step 623 to allocate a dedicated orthogonal code (e.g., a dedicated PN code) or a dedicated time slot to the mobile subscriber station, such that the mobile subscriber station can perform a bandwidth request for the realtime packet service in the contention-free scheme. When the mobile subscriber station receives the DL-USCCH signal, the mobile subscriber station confirms dedicated orthogonal code information included in the DL-USCCH and performs a bandwidth request through a fast access channel (i.e., through an UL-FACCH signal) based on a contention-free scheme by means of the allocated dedicated orthogonal code in step 625.

The base station, having received the UL-FACCH signal, performs a scheduling operation according to the size of a bandwidth, which is included in the UL-FACCH signal, requested by the mobile subscriber station, and transmits the requested bandwidth to the relevant mobile subscriber station through a DL-USCCH signal in step 627. The mobile subscriber station, after receiving the DL-USCCH from the base station, reads the DL-USCCH signal and transmits data for the realtime packet service to the base station through a relevant burst traffic channel (i.e., UL-BTCH) according to the UL-BTCH included in the DL-USCCH signal in step 629.

Thereafter, as described above, the mobile subscriber station repeats the steps of transmitting a UL-FACCH signal to request a required bandwidth, of being allocated a UL-BTCH from the base station, and of transmitting data through the allocated UL-BTCH. As a result, the mobile subscriber station can be provided with the realtime packet service.

Because a service requested by the mobile subscriber station is a realtime packet service, the procedure for the request, allocation, and transmission is performed continuously and repeatedly in realtime every time and is performed in a predetermined transmission period of time. Further, the realtime packet service requires that the base station continuously allocates a channel for a relevant mobile subscriber station at every predetermined transmission interval. It is assured that the base station allocates a requested bandwidth to the mobile subscriber station according to the size of bandwidth requested by the mobile subscriber station within the predetermined transmission interval.

FIG. 6C is a flowchart illustrating a signal flow procedure between a mobile subscriber station and a base station when the mobile subscriber station requests a non-realtime packet service (nrtPS) to the base station in a broadband wireless access communication system according to an embodiment of the present invention. Referring to FIG. 6C, the mobile subscriber station requests bandwidth allocation for the non-realtime packet service from the base station by transmitting the UL-ACCH signal to the base station in step 641. The transmitted UL-ACCH signal includes information indicating that a service required by the mobile subscriber station through the bandwidth allocation request is a non-realtime packet service. The base station, having received the UL-ACCH signal from the mobile subscriber station, reads service class information included in the UL-ACCH signal and recognizes that the mobile subscriber station requests the non-realtime packet service.

The base station transmits a DL-USCCH signal to the mobile subscriber station in step 643 to allocate a dedicated orthogonal code (e.g., a dedicated PN code) or a dedicated time slot to the mobile subscriber station, such that the mobile subscriber station can perform a bandwidth request for the non-realtime packet service in the contention-free scheme. When the mobile subscriber station receives the DL-USCCH signal, the mobile subscriber station confirms dedicated orthogonal code information included in the DL-USCCH and performs a bandwidth request through a fast access channel (i.e., through an UL-FACCH signal) based on a contention-free scheme by means of the allocated dedicated orthogonal code in step 645.

The base station, after receiving the UL-FACCH signal, performs a scheduling operation according to the size of a bandwidth, which is included in the UL-FACCH signal, requested by the mobile subscriber station, and transmits burst traffic transmission bandwidth information for the mobile subscriber station to the relevant mobile subscriber station through a DL-USCCH signal in step 647. The mobile subscriber station, having received the DL-USCCH from the base station, reads the DL-USCCH signal and transmits data for the non-realtime packet service to the base station through a relevant burst traffic channel (i.e., UL-BTCH) according to the UL-BTCH included in the DL-USCCH signal in step 649.

Thereafter, as described above, the mobile subscriber station repeats the steps of transmitting an UL-FACCH signal to request a required bandwidth, of being allocated an UL-BTCH from the base station, and of transmitting data through the allocated UL-BTCH, such that the mobile subscriber station receives the non-realtime packet service.

Because a service requested by the mobile subscriber station is a non-realtime packet service, the procedure for the request, allocation, and transmission is performed through an UL-FACCH signal according to a dedicated orthogonal code allocated to the mobile subscriber station whenever it is necessary to transmit data. The data transmission interval in the non-realtime packet service varies, as opposed to the realtime packet service.

FIG. 6D is a flowchart illustrating a signal flow procedure between a mobile subscriber station and a base station when the mobile subscriber station requests a best effort service to the base station in a broadband wireless access communication system according to an embodiment of the present invention. Referring to FIG. 6D, the mobile subscriber station requests bandwidth allocation for the best effort service from the base station by transmitting the UL-ACCH signal to the base station in step 661. The transmitted UL-ACCH signal includes information indicating that a service required by the mobile subscriber station through the bandwidth allocation request is a best effort service. The base station, having received the UL-ACCH signal from the mobile subscriber station, reads service class information included in the UL-ACCH signal and recognizes that the mobile subscriber station requests the best effort service. When the best effort service is set to a default value, the base station designates and processes a service requested by the mobile subscriber station as a best effort service when an UL-ACCH transmitted from the mobile subscriber station does not include requested service information.

The base station transmits a DL-USCCH signal to the mobile subscriber station in step 663 to inform the relevant mobile subscriber station of burst traffic transmission bandwidth information for the best effort service of the mobile subscriber station. The mobile subscriber station, having received the DL-USCCH from the base station, reads the DL-USCCH signal and transmits data, which is requested, to the base station through a relevant burst traffic channel (i.e., UL-BTCH) according to the UL-BTCH included in the DL-USCCH signal in step 665.

Thereafter, the mobile subscriber station is provided with the best effort service whenever the mobile subscriber station has data to be transmitted by repeating the steps of transmitting an UL-ACCH signal based on the contention-free scheme to request a required bandwidth in step 667, of receiving a DL-USCCH signal from the base station to be allocated an UL-BTCH in step 669, and of transmitting data through the allocated UL-BTCH in step 671.

Because the best effort service is used for one-time bandwidth allocation, the mobile subscriber station performs a new allocation request through the contention-based scheme whenever data to be transmitted from the mobile subscriber station is generated.

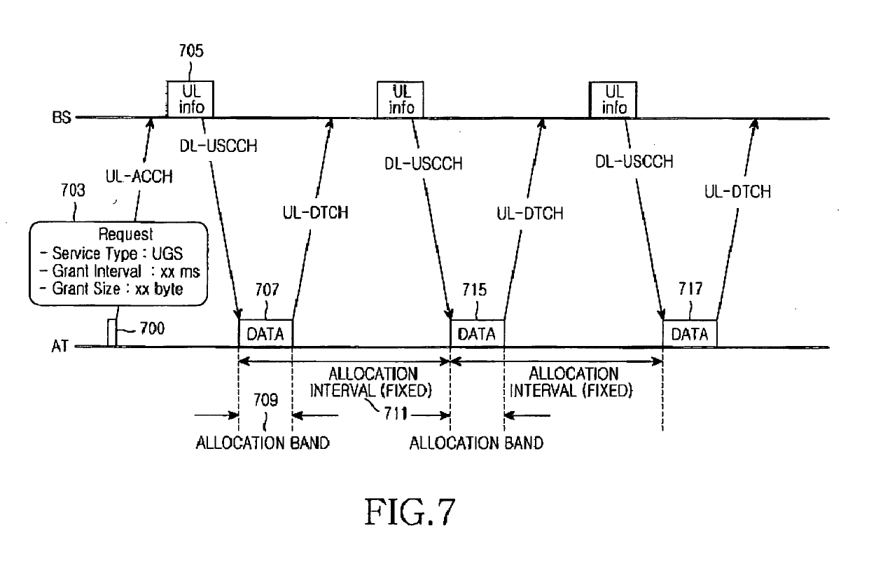

FIG. 7 is a flowchart illustrating a message transmission/reception procedure for an UGS between a base station and a mobile subscriber station according to an embodiment of the present invention. Referring to FIG. 7, when data to be transmitted from a mobile subscriber station is generated, the mobile subscriber station transitions into an access state in step 700 to access a base station. The access state that the mobile subscriber station enters corresponds to the access state 217, which was described above with reference to FIG. 2. The mobile subscriber station determines a bandwidth request message 703 required for a UGS request to the base station and transmits the bandwidth request message for the UGS to the base station through a UL-ACCH signal based on the contention-based scheme.

The mobile subscriber station enters the access state as described above, and then transmits the determined request message to the base station using the UL-ACCH signal, such that the message transmission is performed to attempt to access the base station in the contention-based scheme. Information in the request message transmitted from the mobile subscriber station to the base station includes service type information of notifying that a requested service class corresponds to the UGS, allocation interval (Grant Interval) information 711 for indicating a bandwidth allocation interval, and allocation bandwidth size (Grant Size) information 709 for indicating a size of a periodically allocated bandwidth.

The base station, having received the request message through the UL-ACCH, recognizes that the type of the requested service corresponds to the UGS, and allocates a wireless interval and a system resource to the mobile subscriber station. The allocated wireless interval and system resource is inserted into uplink information 705 to be transmitted to the mobile subscriber station through a DL-USCCH signal.

The mobile subscriber station, having received the DL-USCCH, generates data 707 having the same size as that of the requested bandwidth and transmits the data 707 to the base station through an allocated dedicated channel, i.e., through an UL-DTCH.

While the access is being maintained, the base station continuously and periodically 711 allocates an uplink bandwidth to the mobile subscriber station, although the mobile subscriber station does not repeat a bandwidth allocation request for the UGC through the access procedure of the contention-based scheme as described above. According to a bandwidth allocated from the base station, the mobile subscriber station fixedly transmits data 707, 715, and 717 of a size corresponding to the allocated bandwidth for the UGS.

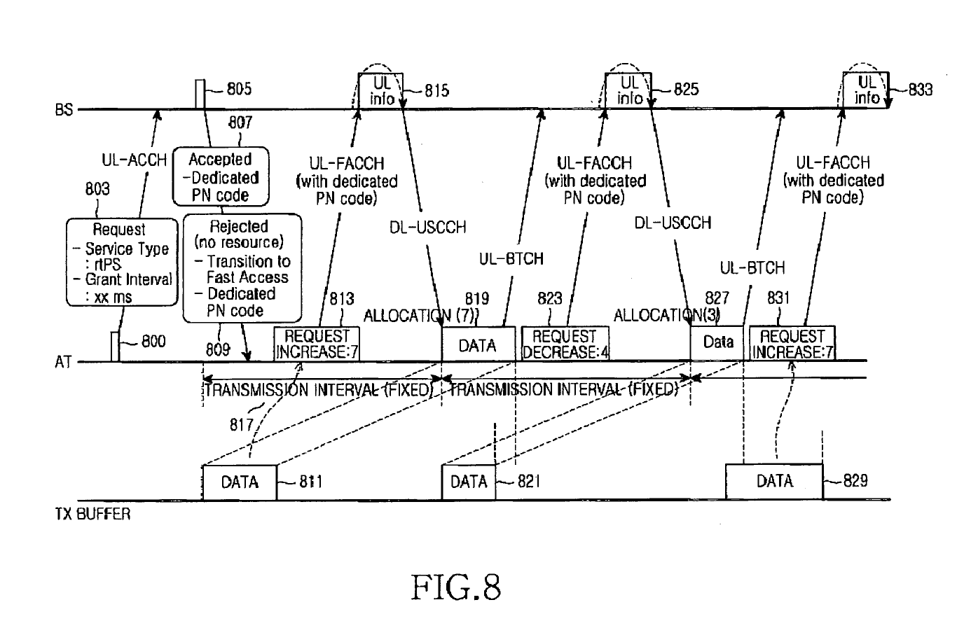

FIG. 8 is a flowchart illustrating a message transmission/reception procedure for a realtime packet service between a base station and a mobile subscriber station according to an embodiment of the present invention. Referring to FIG. 8, when a mobile subscriber station must connect for a realtime packet service, the mobile subscriber station enters an awake mode in step 800 and transmits a request message 803 to a base station through a UL-ACCH. The request message 803 includes a service type field indicating that a requested service corresponds to a realtime packet service. Further, the request message 803 includes a transmission interval (Grant Interval) information field for indicating an interval of a bandwidth to be allocated.

The base station, having received the request message 803, transmits an acceptance message 807 to accept the requested service when it is possible to provide the requested service, but transmits a rejection message 809 to reject the requested service when it is impossible to provide the requested service, according to wireless channel and system resource environments.

When the base station accepts the requested service, the base station allocates and transmits a dedicated orthogonal code (e.g., a dedicated PN code), which only the relevant mobile subscriber station can dedicatedly use, to the mobile subscriber station. However, when the base station, having received the request message, rejects the requested service, the base station allocates and transmits a dedicated orthogonal code (e.g., a dedicated PN code), which only the relevant mobile subscriber station can dedicatedly use when attempting re-access, to the mobile subscriber station.

Although the requested service is rejected, the mobile subscriber station, having received the dedicated orthogonal code through the above step, uses the allocated dedicated orthogonal code when re-transmitting the request message, such that the mobile subscriber station can access the base station in a contention-free scheme through a UL-FACCH, not in a contention-based scheme through the UL-ACCH.

The mobile subscriber station first stores data 811 generated in the mobile subscriber station in a transmission buffer (Tx buffer), records the size of a bandwidth corresponding to the amount of the generated data in a request message, and transmits the request message to the base station through the UL-FACCH. In FIG. 8, the size of data to be transmitted is set to ‘7’. Accordingly, the mobile subscriber station requests allocation of a bandwidth having a size as large as ‘7’.

The mobile subscriber station performs a CDMA scrambling operation with respect to the request message to be transmitted using the dedicated orthogonal code, which is allocated for data transmission to the base station in the service request acceptance step, and then transmits the request message. Because the dedicated orthogonal code used by the mobile subscriber station is a code that only the relevant mobile subscriber station dedicatedly uses, it is assured that the mobile subscriber station can transmit a request message without any collision with other mobile subscriber stations.

The base station receives a request of a bandwidth size that the mobile subscriber station desires to be allocated for the next transmission interval 817 and allocates an uplink bandwidth to the relevant mobile subscriber station through a DL-USCCH. The size of the allocated bandwidth is ‘7’ requested through the request message 813. The mobile subscriber station is allocated the uplink bandwidth through the DL-USCCH signal and then transmits data 811, which is stored for transmission in the transmission buffer of the mobile subscriber station, to the base station through an UL-BTCH signal using the allocated uplink bandwidth.

When the second data 821 generated in the mobile subscriber station is stored in the transmission buffer for the next transmission, the mobile subscriber station compares the size of the second data 821 with the size of the first data 811 and determines whether the size of the second data 821 increase or decrease on the basis of that of the first data 811. The mobile subscriber station determines the second message 823 including the increasing/decreasing size of data and transmits the second message 823 to the base station through the UL-FACCH. In FIG. 8, the size of the second data 821 is determined as a smaller value than that of the first 811 by ‘4’. Therefore, the second request message 823 includes data size variation indication of ‘Decrease: 4’.

When the base station receives the second request message from the mobile subscriber station (i.e., a bandwidth allocation request message), the base station applies the data variation indication of ‘Decrease: 4’, which is requested bandwidth information 825, to the size ‘7’ of the previous bandwidth . As a result, the base station allocates an uplink bandwidth as large as ‘3’ obtained by subtracting ‘3’ from ‘7’ and transmits the allocated uplink bandwidth to the mobile subscriber station.

When data to be transmitted from the mobile subscriber station to the base station has the same size as that of the previous transmitted data, the mobile subscriber station does not transmit a bandwidth request message to the base station. While the same realtime packet service is being maintained, if the base station does not receive a message of notifying whether the size of a bandwidth to be used in the next frame increases or decreases from the mobile subscriber station, the base station recognizes that the mobile subscriber station desires to transmit data having the same size of that of the previous frame, thereby allocating an uplink bandwidth having the same size of that of the previous allocated uplink bandwidth to the mobile subscriber station.

The mobile subscriber station, having requested a bandwidth to the base station, transmits the second data 821 stored in the own transmission buffer to the base station through an allocated UL-BTCH signal as described above. As described above, the mobile subscriber station requests the size of a bandwidth, which is desired to be allocated, from the base station, through the UL-FACCH signal at every predetermined interval 817 and is allocated a bandwidth from the base station through the DL-USCCH.

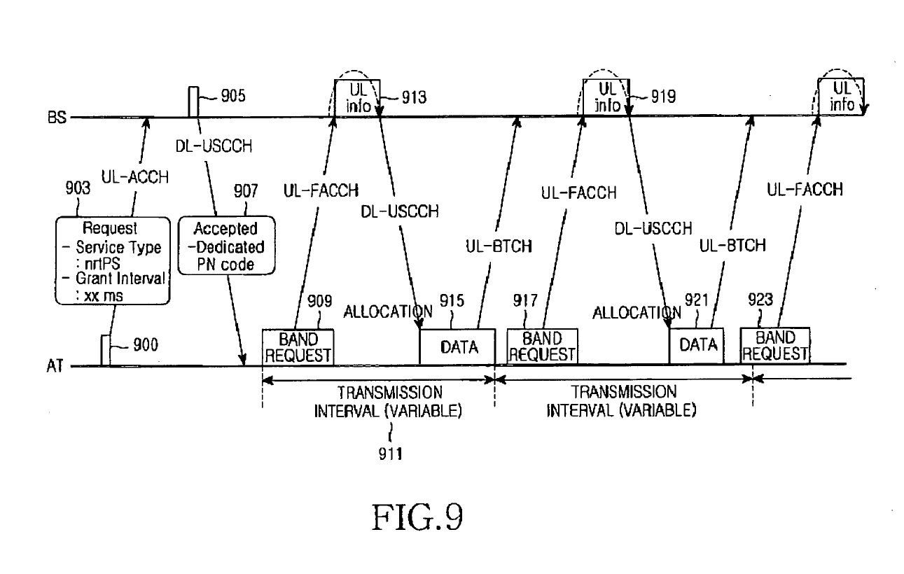

FIG. 9 is a flowchart illustrating a message transmission/reception procedure for a non-realtime packet service between a base station and a mobile subscriber station according to an embodiment of the present invention. Referring to FIG. 9, the mobile subscriber station requesting connection for a non-realtime packet service generates a bandwidth allocation request message 903 for the non-realtime packet service. The bandwidth allocation request message 903 generated in the mobile subscriber station includes a service type field that indicates that a requested service is a non-realtime packet service (nrtPS), and in this case, the service type is represented as a non-realtime packet service (nrtPS).

The base station, having received the bandwidth allocation request message 903, recognizes that a service requested by the mobile subscriber station is the non-realtime packet service in step 905, and transmits a service acceptance message 907 to the relevant mobile subscriber station through a DL-USCCH signal. The base station inserts a dedicated orthogonal code (i.e., a dedicated PN code) into the service acceptance message 907 and then transmits the service acceptance message 907 to the mobile subscriber station. The mobile subscriber station generates a request message 909 for an uplink bandwidth, which has a size corresponding to that of data to be transmitted, using the dedicated orthogonal code (i.e., the dedicated PN code) that is included in the service acceptance message 907 received from the base station, and then transmits the request message 909 to the base station.

The base station, having received the bandwidth allocation request message 909, allocates a bandwidth according to uplink information (UL info) 913, which the base station schedules, and transmits allocated bandwidth information to the mobile subscriber station through the DL-USCCH signal. The mobile subscriber station, having acquired available bandwidth information through the above-mentioned steps, transmits data 915 using the allocated bandwidth.

As described above, the mobile subscriber station transmits an uplink bandwidth allocation request message 917 including size information of data to be transmitted to the base station. The base station allocates an uplink bandwidth to the mobile subscriber station in step 919. Thereafter, the mobile subscriber station transmits data 921 using the allocated bandwidth.

As described above, when data to be transmitted from the mobile subscriber station is generated, the mobile subscriber station transmits a bandwidth allocation request message using an allocated dedicated orthogonal code and then transmits the data through an allocated bandwidth.

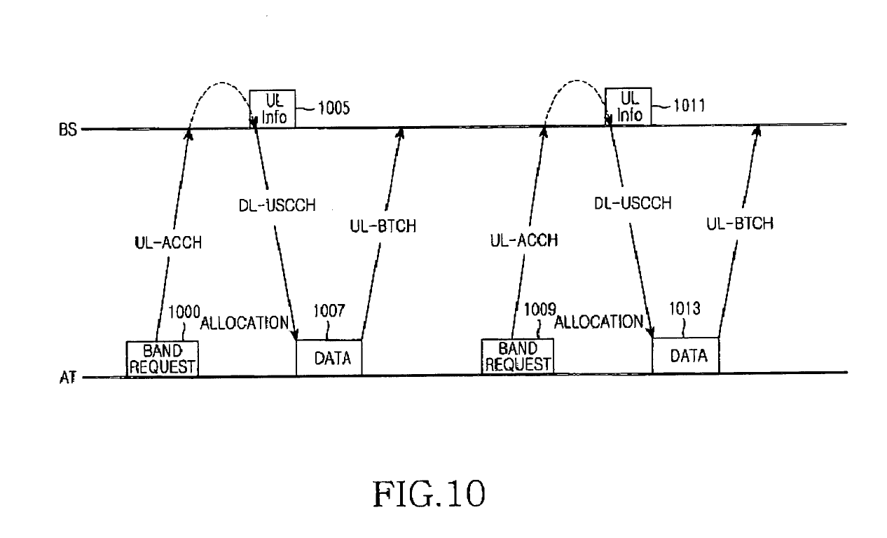

FIG. 10 is a flowchart illustrating a message transmission/reception procedure for a best effort service between a base station and a mobile subscriber station according to an embodiment of the present invention. Referring to FIG. 10, when there is data to be transmitted from the mobile subscriber station to the base station, the mobile subscriber station transmits an uplink bandwidth allocation request message 1000 by an UL-ACCH through contention-based access. In the best effort service, because the mobile subscriber station attempts to channel access in a contention-based scheme, the request message transmitted from the mobile subscriber station may collide with other messages transmitted from other mobile subscriber stations. When the request message transmitted from the mobile subscriber station collides with another message, the mobile subscriber station waits for a predetermined period of time and then re-transmits the request message. Consequently, transmission delay may occur.

The base station, having received the bandwidth allocation request message 1000, allocates a bandwidth according to environments of wireless links and system resources in step 1005 and transmits the allocated information to the mobile subscriber station through a DL-USCCH signal. The mobile subscriber station, having been allocated the requested bandwidth from the base station, transmits data 1007 through an allocated UL-BTCH.

As described above, whenever data to be transmitted from the mobile subscriber station to the base station is generated, the mobile subscriber station transmits a bandwidth allocation request message 1000 or 1009 in a contention-based scheme. Thereafter, the mobile subscriber station is allocated a bandwidth, and then transmits data 1007 or 1013 to the base station using the allocated bandwidth.

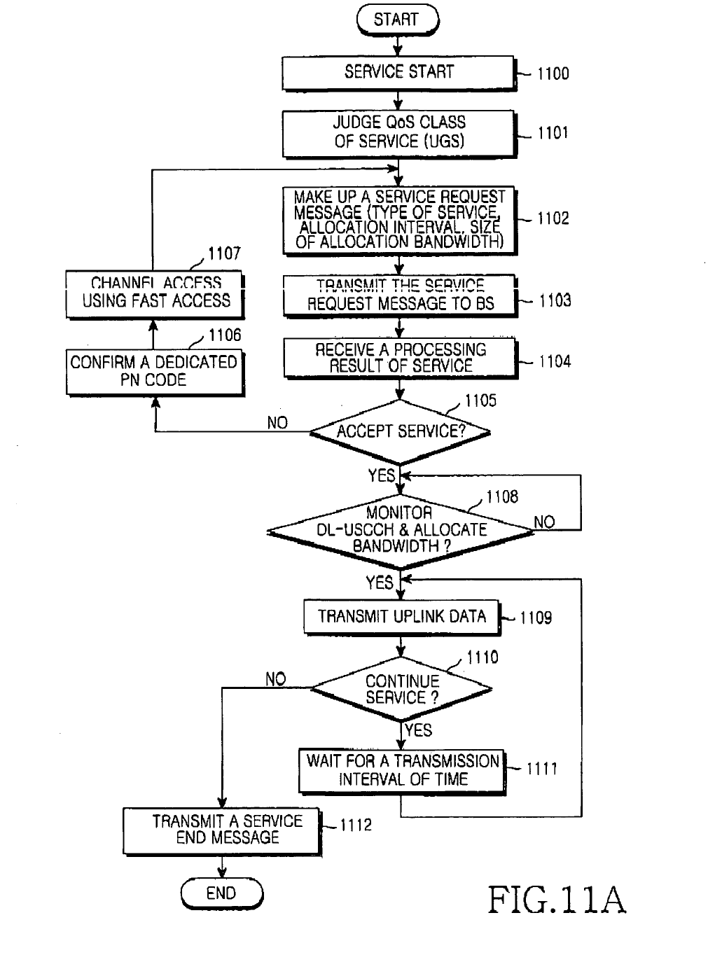

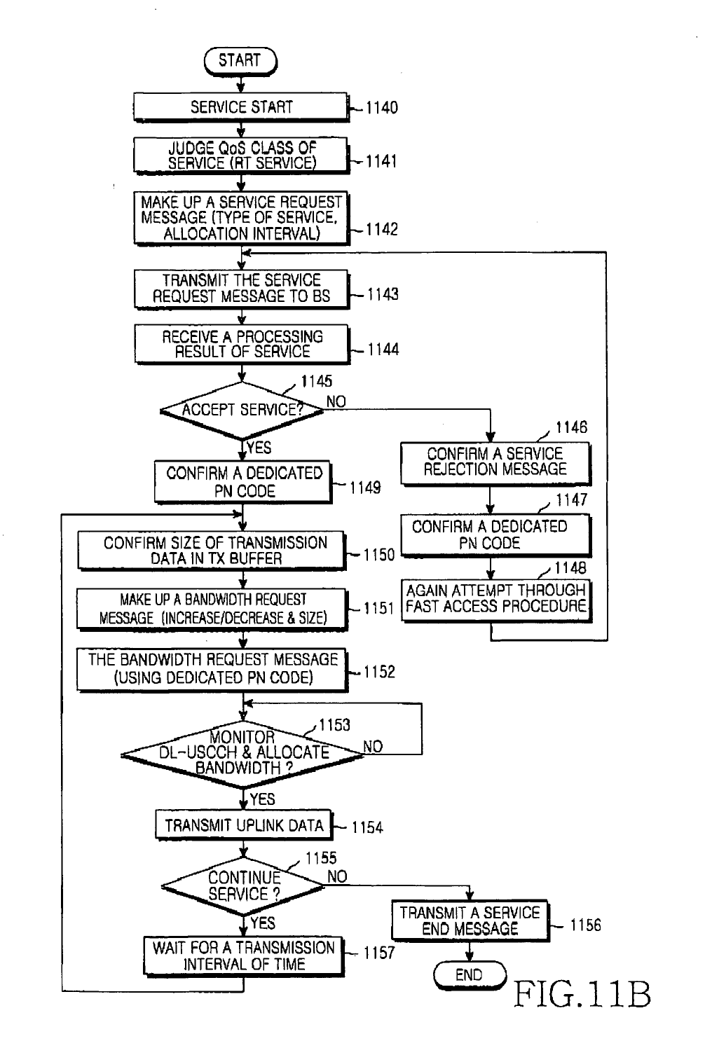

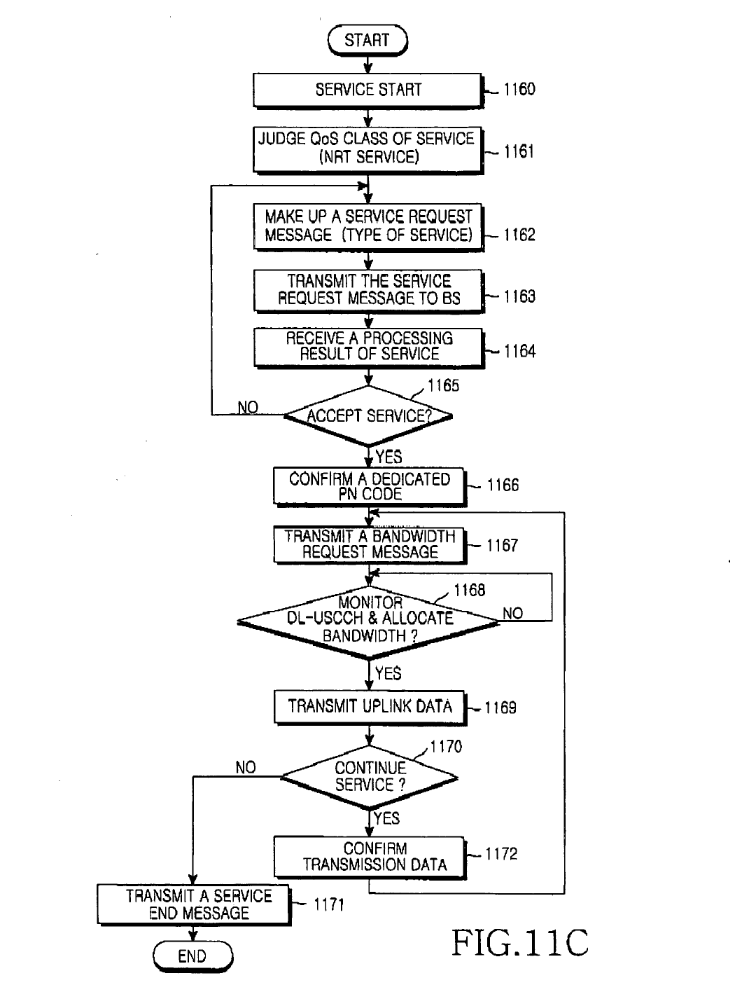

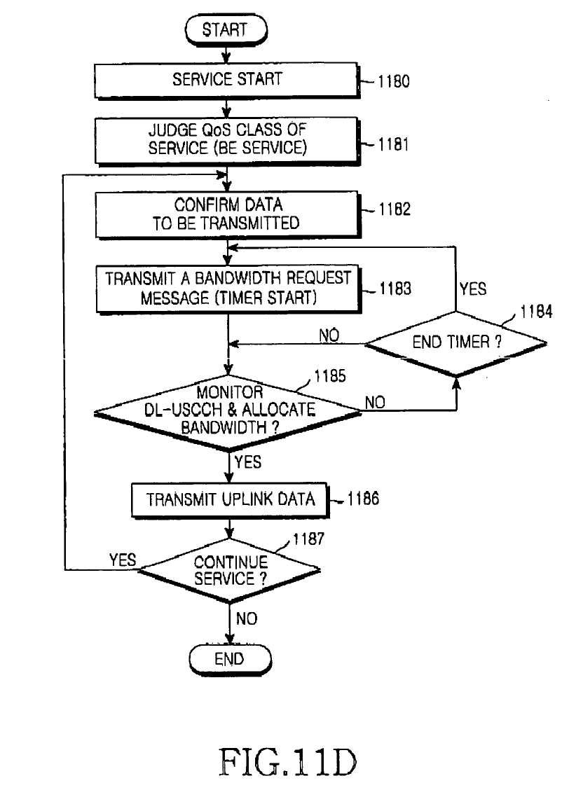

FIG. 11A is a flowchart illustrating an operation of a mobile subscriber station for requesting a UGS according to an embodiment of the present invention. Referring to FIG. 11A, the mobile subscriber station starts a service according to the operation of an upper application in step 1100. The mobile subscriber station determines the class of a service to be requested in step 1101. In this embodiment, the following steps are performed on the assumption that the class of the service to be requested corresponds to a UGS.

When the service to be requested by the mobile subscriber station is the UGS, the mobile subscriber station creates a message for requesting the service in step 1102. The message includes information related to a type of the service, the size of a bandwidth desired to be allocated, and a transmission interval of the bandwidth desired to be allocated.

Thereafter, the mobile subscriber station transmits the message to the base station in step 1103 and waits for a processing result of the service request to be received from the base station in step 1104. The mobile subscriber station receives the processing result of the service request in step 1104 and checks the processing result.

When the base station rejects the requested service in step 1105, the mobile subscriber station confirms dedicated orthogonal code information included in the processing result message transmitted from the base station in step 1106. The mobile subscriber station performs fast access to the base station using the dedicated orthogonal code in step 1107, thereby again requesting a bandwidth to the base station.

However, when the base station accepts the requested service in step 1105, the mobile subscriber station confirms whether or not the requested bandwidth is normally allocated by checking a received massage, that is, a DL-USCCH signal in step 1108. When the bandwidth requested by the mobile subscriber station is normally allocated, the mobile subscriber station transmits uplink data using the allocated bandwidth in step 1109. Thereafter, when it is necessary to continue providing (progress) the UGS in step 1110, the mobile subscriber station waits for a predetermined transmission interval of time in step 1111 and then transmits data using the allocated dedicated bandwidth as described above in step 1109.

However, when the mobile subscriber station wants to end the UGS in step 1110, the mobile subscriber station transmits a service end message to the base station in step 1112, and ends the procedure for the UGS.

FIG. 11B is a flowchart illustrating an operation of a mobile subscriber station for requesting a realtime packet service according to an embodiment of the present invention. Referring to FIG. 11B, the mobile subscriber station starts a service according to the operation of an upper application in step 1140. The mobile subscriber station determines the class of a service to be requested in step 1141. In this embodiment, the following steps are performed on the assumption that the class of the service to be requested corresponds to a realtime packet service (rtPS).

When the service to be requested by the mobile subscriber station is the realtime packet service, the mobile subscriber station creates a message for requesting the service in step 1142. The message includes information related to a type of the service and an interval of a bandwidth desired to be allocated. In this case, the message does not include information of the size of the requested bandwidth and the mobile subscriber station requests a bandwidth having a size required whenever the mobile subscriber station wants to transmit data to the base station. That is, unlike the UGS, because a bandwidth required in the realtime packet service varies, bandwidth information is not transmitted in the service request step.

The mobile subscriber station, having created the message for the service request, transmits the made-up message to the base station in step 1143 and waits for a processing result of the service request to be received from the base station in step 1144. The mobile subscriber station receives the processing result of the service request in step 1144, and checks the processing result.

When the base station rejects the requested service in step 1145, the mobile subscriber station confirms a service rejection message transmitted from the base station in step 1146 and confirms dedicated orthogonal code information included in the processing result message transmitted from the base station in step 1147. The mobile subscriber station performs fast access to the base station using the dedicated orthogonal code in step 1148, thereby again requesting a bandwidth to the base station.

However, when the base station accepts the requested service in step 1145, the mobile subscriber station confirms a dedicated orthogonal code, which is allocated from the base station to the mobile subscriber station through a received message in step 1149.

Thereafter, the mobile subscriber station confirms the size of data to be transmitted in the transmission buffer (Tx buffer) in which the data for transmission have been stored in step 1150. The mobile subscriber station compares the confirmed size information of the data with the size of the previous allocated bandwidth, creates a bandwidth allocation request message in step 1151, in which “Increase” for representing the increase of data or “Decrease” for representing the decrease of data is recorded together with an actual difference value between the sizes of the two data, and transmits the bandwidth allocation request message to the base station in step 1152. In this case, the mobile subscriber station transmits the bandwidth allocation request message to the base station through a UL-FACCH using the dedicated orthogonal code (e.g., a dedicated PN code), which was confirmed in step 1149.

After the mobile subscriber station transmits the bandwidth allocation request message to the base station, the mobile subscriber station waits for an actual bandwidth to be allocated while checking a DL-USCCH to determine whether or not an actual bandwidth is allocated in step 1153). When a bandwidth is allocated, the mobile subscriber station transmits data to the base station using the allocated bandwidth in step 1154.

After the mobile subscriber station transmits data, the mobile subscriber station determines whether or not the mobile subscriber station is provided with the relevant service according to the determination of an upper application in step 1155. When the mobile subscriber station wants to end the relevant service, the mobile subscriber station transmits a service end message to the base station in step 1156, thereby ending the relevant service.

However, when the mobile subscriber station wants to be provided with the relevant service, the mobile subscriber station waits for a transmission interval of time predetermined for the realtime packet service in step 1157 and then returns to step 1150 in order to repeat the procedure of calculating the size of data to be transmitted and of transmitting a bandwidth allocation request message.

FIG. 11C is a flowchart illustrating an operation of a mobile subscriber station for requesting a non-realtime packet service according to an embodiment of the present invention. Referring to FIG. 11C, the mobile subscriber station starts a service according to the operation of an upper application in step 1160. The mobile subscriber station determines the class of a service to be requested in step 1161. In this embodiment, the following steps are performed on the assumption that the class of the service to be requested corresponds to a non-realtime packet service (nrtPS).

When the service to be requested by the mobile subscriber station is the non-realtime packet service, the mobile subscriber station creates a message for requesting the service in step 1162. The message includes information related to a type of the service and an interval of a bandwidth desired to be allocated. When the class of the service corresponds to a non-realtime packet service, the mobile subscriber station creates a service request message to be transmitted to the base station in step 1162. In this case, the mobile subscriber station does not request a bandwidth allocation interval and a bandwidth size but transmits the service request message including only information of a service type to the base station in step 1163.

The mobile subscriber station receives a processing result of the service request, which is transmitted to the base station through the step, from the base station in step 1164, and determines whether or not the requested service is accepted with the processing result in step 1165.

When the requested service is rejected in step 1165, the mobile subscriber station returns to step 1162, thereby again transmitting the service request message. However, when the requested service is accepted in step 1165, the mobile subscriber station confirms a dedicated orthogonal code (e.g., a dedicated PN code) included in a processing result message transmitted from the base station in step 1166, and transmits information of a bandwidth, which the mobile subscriber station desires to request, through a fast access channel of a contention-free scheme, i.e., through an UL-FACCH using the received dedicated orthogonal code in step 1167.

The mobile subscriber station waits for an actual bandwidth to be transmitted while monitoring the DL-USCCH signal in step 1168. When the mobile subscriber station is allocated an actual bandwidth, the mobile subscriber station transmits data through an uplink channel (e.g., an uplink burst channel) according to the allocated bandwidth in step 1169.

After the mobile subscriber station transmits data, the mobile subscriber station determines whether or not to continue service in step 1170. When the mobile subscriber station wants to end the relevant service, the mobile subscriber station transmits a service end message to the base station in step 1171, and the relevant service is ended. However, when the mobile subscriber station wants to be provided with the relevant service, the mobile subscriber station checks if there is data to be transmitted in step 1172 and again transmits a bandwidth allocation request message to the base station.

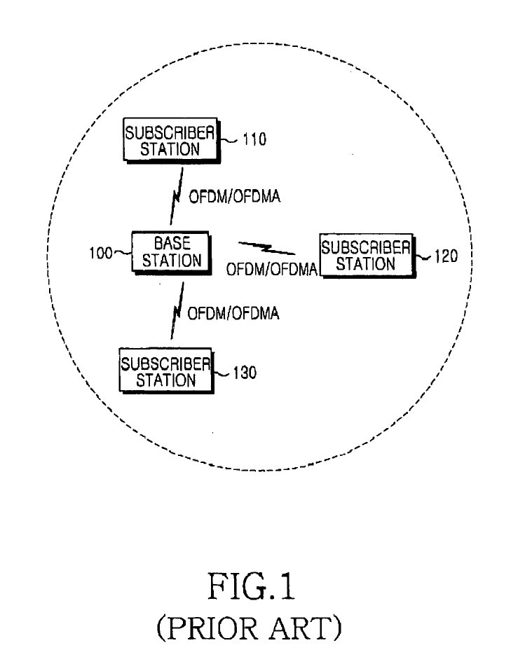

FIG. 11D is a flowchart illustrating an operation of a mobile subscriber station for requesting a best effort service according to an embodiment of the present invention. Referring to FIG. 1D, the mobile subscriber station starts a service according to the operation of an upper application in step 1180. The mobile subscriber station determines the class of a service to be requested in step 1181. In this embodiment, the following steps are performed on the assumption that the class of the service to be requested corresponds to a best effort service.

When the type of a requested service corresponds to a best effort service, the base station does not assure the mobile subscriber station of bandwidth allocation. Therefore, the mobile subscriber station confirms data to be transmitted in step 1182 and transmits an uplink bandwidth allocation request message to the base station through an uplink access channel (i.e., UL-ACCH) of the contention-based scheme in step 1183.

After the mobile subscriber station transmits the bandwidth allocation request message to the base station, the mobile subscriber station confirms whether or not an actual bandwidth is allocated while monitoring a DL-USCCH signal in step 1185. When the mobile subscriber station is not allocated a bandwidth for a period of time preset in a timer and the period of time preset in the timer elapses in step 1184, the mobile subscriber station proceeds to step 1183, thereby re-transmitting the bandwidth allocation request message in step 1183. However, when the mobile subscriber station is allocated an uplink bandwidth through the DL-USCCH signal, the mobile subscriber station transmits data through the allocated bandwidth in step 1186.

When the mobile subscriber station wants to be provided with the relevant service in step 1187, the mobile subscriber station returns to step 1182 and must again perform all the above-mentioned steps (steps 1182 to step 1187). That is, when the mobile subscriber station wants to be again provided with the relevant service, the mobile subscriber station must be allocated a new bandwidth through an access attempt according to the contention-based access procedure.

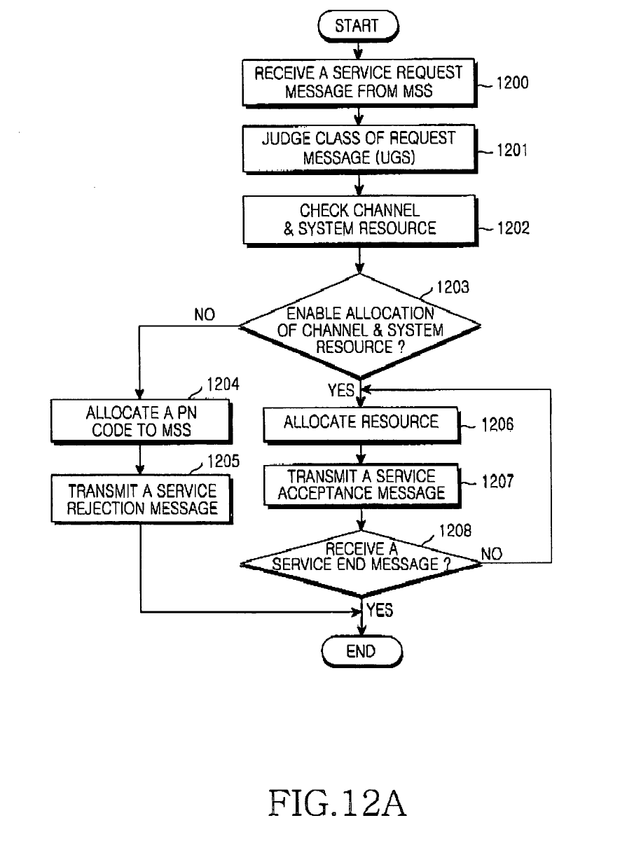

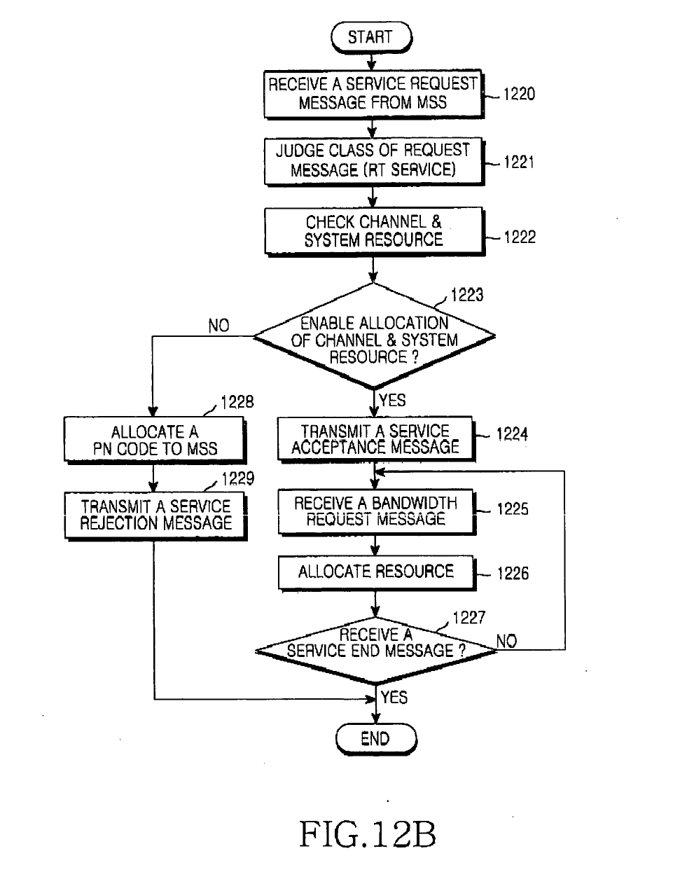

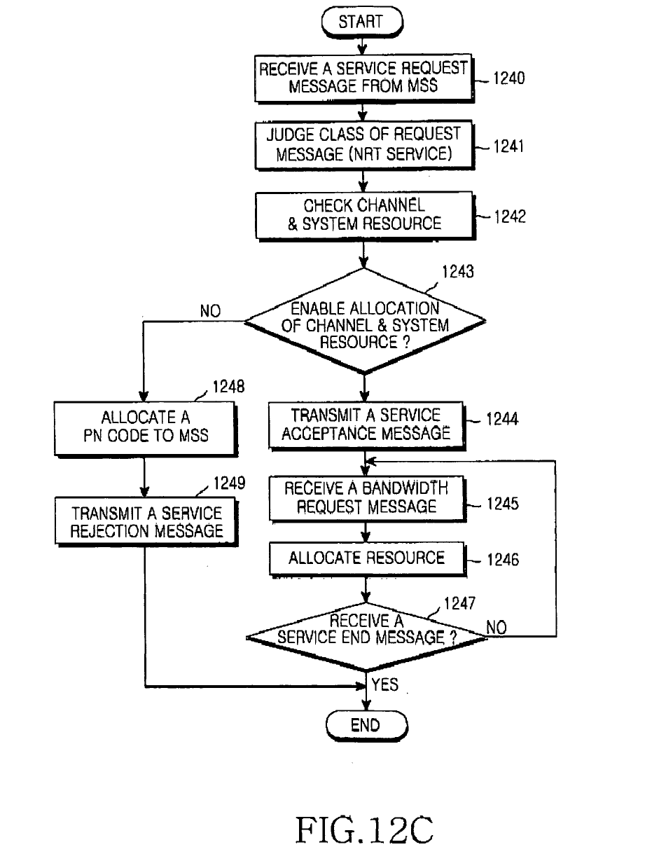

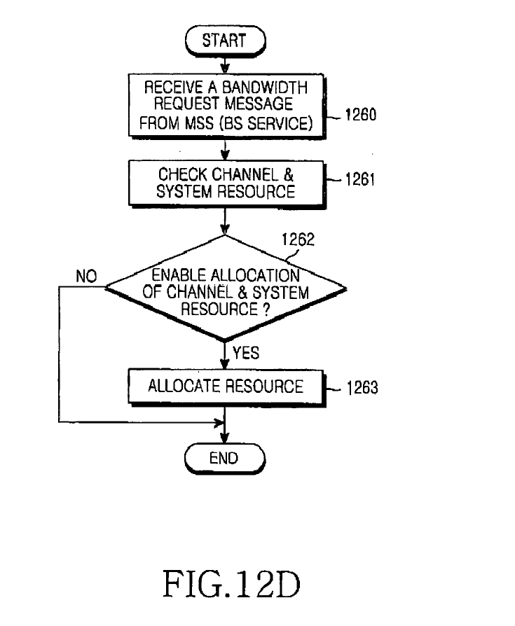

FIG. 12A is a flowchart illustrating an operation of a base station for providing a UGS according to an embodiment of the present invention. Referring to FIG. 12A, a base station receives a service request message from a mobile subscriber station in step 1200 and determines the type of a service class represented in the service request message in step 1201.

When the base station receives a UGS request from the mobile subscriber station, the base station checks whether or not there is a resource to be provided for the requested service in step 1202 and determines whether or not a resource can be allocated according to checked channel and system resource information in step 1203.

When a resource can be allocated, the base station proceeds to step 1206. However, when a resource cannot be allocated, the base station proceeds to step 1204.

When the base station judges that resources are lacking, the base station allocates a dedicated orthogonal code (e.g., a dedicated PN code) to the mobile subscriber station in step 1204, such that the mobile subscriber station can perform a reliable access through a fast access channel when attempting re-access, and transmits a service rejection message including information of the allocated dedicated orthogonal code to the relevant mobile subscriber station in step 1205.

However, when the base station determines that a resource can be allocated, the base station allocates a resource to the mobile subscriber station in step 1206 and transmits a service acceptance message to the mobile subscriber station in step 1207. When the base station receives a service end message from the mobile subscriber station in step 1208, the base station ends the service provision. However, when the base station does not receive the service end message from the mobile subscriber station, the base station returns to step 1206, and allocates a resource for the next interval to the mobile subscriber station.

FIG. 12B is a flowchart illustrating an operation of a base station for providing a realtime packet service according to an embodiment of the present invention. Referring to FIG. 12B, a base station receives a service request message from a mobile subscriber station in step 1220 and determines the type of a service class represented in the service request message in step 1221. When the base station receives a realtime packet service request from the mobile subscriber station, the base station checks whether or not there is a resource to be provided for the requested service in step 1222 and determines whether or not a resource can be allocated according to checked channel and system resource information in step 1223. When a resource can be allocated, the base station proceeds to step 1224. However, when a resource cannot be allocated, the base station proceeds to step 1228.

When the base station determines that a resource can be allocated, the base station transmits a service acceptance message to the relevant mobile subscriber station in step 1224 and waits for the reception of a bandwidth allocation request message transmitted from the mobile subscriber station. When the base station receives the bandwidth allocation request message from the mobile subscriber station in step 1225, the base station allocates a resource to the relevant mobile subscriber station according to the received bandwidth allocation request message in step 1226.

When the base station receives a service end message from the mobile subscriber station in step 1227, the base station ends the service provision. However, when the base station does not receive the service end message from the mobile subscriber station, the base station returns to step 1225, and receives a bandwidth allocation request message from the mobile subscriber station.

When the base station determines that there is no resource to be allocated to the mobile subscriber station, the base station allocates a dedicated orthogonal code to the mobile subscriber station in step 1228 and transmits a service rejection message including information of the allocated dedicated orthogonal code to the mobile subscriber station in step 1229.

FIG. 12C is a flowchart illustrating an operation of a base station for providing a non-realtime packet service according to an embodiment of the present invention. Referring to FIG. 12C, a base station receives a service request message from a mobile subscriber station in step 1240, and determines the type of a service class represented in the service request message in step 1241. When the base station receives a non-realtime packet service request from the mobile subscriber station, the base station checks whether or not there is a resource to be provided for the requested service in step 1242 and determines whether or not a resource can be allocated according to checked channel and system resource information in step 1243. When a resource can be allocated, the base station proceeds to step 1244. However, when a resource cannot be allocated, the base station proceeds to step 1248.

More specifically, when the base station determines that a resource can be allocated, the base station transmits a service acceptance message to the relevant mobile subscriber station in step 1244 and waits for the reception of a bandwidth allocation request message transmitted from the mobile subscriber station. When the base station receives the bandwidth allocation request message from the mobile subscriber station in step 1245, the base station allocates a resource to the relevant mobile subscriber station according to the received bandwidth allocation request message in step 1246.

Thereafter, when the base station receives a service end message from the mobile subscriber station, the base station ends the service provision. However, when the base station does not receive the service end message from the mobile subscriber station, the base station returns to step 1245, and waits until receiving a bandwidth allocation request message transmitted from the mobile subscriber station in step 1245.

When the base station determines that there is no resource to be allocated to the mobile subscriber station, the base station allocates a dedicated orthogonal code to the mobile subscriber station in step 1248 and transmits a service rejection message including information of the allocated dedicated orthogonal code to the mobile subscriber station in step 1249.

FIG. 12D is a flowchart illustrating an operation of a base station for providing a best effort (BE) service according to an embodiment of the present invention. Referring to FIG. 12D, a base station receives a service request message from a mobile subscriber station in step 1260, and determines the type of a service class represented in the service request message. As described above, the best effort service may be established as a default service. Therefore, when the service request message does not include a specific identifier for a service request (e.g., an identifier representing a UGS, a rtPS, or an nrtPS), the base station may determine that the service request message is made up to request the best effort service. Accordingly, in the case of the best effort service, a step of determining the class of the requested service can be omitted in contrast to the above-mentioned other embodiments.

When the base station receives a best effort service request from the mobile subscriber station, the base station checks whether or not there is a resource to be provided for the requested service in step 1261. When the base station determines that a resource can be allocated, the base station proceeds to step 1263, allocates a resource to the mobile subscriber station in step 1263, and ends the service. However, when the base station determines that a resource cannot be allocated, the base station ends the service without allocating any resource.

As described above, the present invention provides new uplink bandwidth allocation methods for a broadband wireless access communication system, thereby supporting fast data transmission and the mobility of a mobile subscriber station in order to support not only a voice service but also packet-based transmission services according to various QoS. In addition, the present invention provides new bandwidth request procedures suitable to the respective QoS in a broadband wireless access communication system, thereby minimizing time delay required when a mobile subscriber station acquires an uplink bandwidth.

While the present invention has been shown and described with reference to certain preferred embodiments thereof, it will be understood by those skilled in the art that various changes in form and details may be made therein without departing from the spirit and scope of the present invention as defined by the appended claims.

1. A method of receiving a transmission bandwidth for data to be transmitted by a mobile subscriber station according to types of services requested by the mobile subscriber station in the mobile subscriber station in a broadband wireless access communication system in which a plurality of mobile subscriber stations request bandwidth allocation to a base station through a predetermined access channel signal, the method comprising the steps of:
inserting type information of a service requested by the mobile subscriber station into the predetermined access channel signal;
transmitting the predetermined access channel signal to the base station;
receiving uplink scheduling information according to the type of the service requested by the mobile subscriber station from the base station; and
transmitting data using a transmission bandwidth allocated according to the uplink scheduling information.

2. The method as claimed in claim 1, wherein, the type of the service includes at least one of an unsolicited guaranteed service, a realtime packet service, a non-realtime packet service, and a best effort service.

3. The method as claimed in claim 2, wherein, when the service requested by the mobile subscriber station is the unsolicited guaranteed service, the method further comprises the steps of:
inserting information for indicating that the type of the service requested by the mobile subscriber station is the unsolicited guaranteed service in the predetermined access channel signal;
transmitting the predetermined access channel signal to the base station;
receiving a response signal to the transmitted predetermined access channel signal from the base station; and
transmitting data using an allocated transmission bandwidth, when the transmission bandwidth requested by the mobile subscriber station is allocated through the response signal.

4. The method as claimed in claim 3, wherein the predetermined access channel signal transmitted from the mobile subscriber station further includes size information of the bandwidth, which the mobile subscriber station desires to be allocated.

5. The method as claimed in claim 3, wherein the predetermined access channel signal transmitted from the mobile subscriber station further includes allocation interval information of the bandwidth, which the mobile subscriber station desires to be allocated.

6. The method as claimed in claim 3, wherein, when the response signal includes rejection information of the service requested by the mobile subscriber station, the method further comprises the steps of:
identifying a dedicated orthogonal code included in the response signal; and
attempting fast access of a contention-free scheme to the base station using the dedicated orthogonal code.

7. The method as claimed in claim 3, wherein the mobile subscriber station is continuously and dedicatedly allocated the requested bandwidth from the base station at every predetermined period according to the request of the service.

8. The method as claimed in claim 2, wherein, when the service requested by the mobile subscriber station is the realtime packet service, the method further comprises the steps of:
inserting information indicating that the type of the service requested by the mobile subscriber station is the realtime packet service in the predetermined access channel signal;
transmitting the predetermined access channel signal to the base station; receiving a response signal to the transmitted predetermined access channel signal from the base station;
creating a bandwidth request message, when the response signal includes a dedicated orthogonal code;
transmitting the bandwidth request message to the base station through the dedicated orthogonal code;
receiving a requested transmission bandwidth allocated from the base station; and
transmitting data through the allocated transmission bandwidth.

9. The method as claimed in claim 8, wherein the predetermined access channel signal transmitted from the mobile subscriber station further includes transmission interval information of the bandwidth, which the mobile subscriber station desires to be allocated.

10. The method as claimed in claim 8, wherein, when the response signal includes rejection information of the service requested by the mobile subscriber station, the method further comprises the steps of:
identifying the dedicated orthogonal code included in the response signal; and
attempting fast access of a contention-free scheme to the base station using the dedicated orthogonal code.

11. The method as claimed in claim 8, wherein, the mobile subscriber station repeatedly requests a bandwidth to the base station using a pre-allocated dedicated orthogonal code at every predetermined period of time only when there is a size difference between data to be transmitted in a current transmission section and data transmitted in a previous transmission section, such that the mobile subscriber station is allocated the requested bandwidth in realtime.

12. The method as claimed in claim 11, wherein information of the bandwidth request performed at every predetermined period of time includes size difference information between the data to be transmitted in the current transmission section and the data transmitted in the previous transmission section.

13. The method as claimed in claim 2, wherein, when the service requested by the mobile subscriber station is the non-realtime packet service, the method further comprises the steps of:
inserting information indicating that the type of the service requested by the mobile subscriber station is the non-realtime packet service in the predetermined access channel signal;
transmitting the predetermined access channel signal to the base station;
receiving a response signal to the transmitted predetermined access channel signal from the base station;
creating a bandwidth request message when the response signal includes a dedicated orthogonal code;
transmitting the bandwidth request message to the base station through the dedicated orthogonal code;
receiving a requested transmission bandwidth allocated from the base station; and
transmitting data through the allocated transmission bandwidth.

14. The method as claimed in claim 13, wherein the mobile subscriber station re-transmits the bandwidth request message to the base station when the response signal includes rejection information of the service requested by the mobile subscriber station.

15. The method as claimed in claim 2, wherein, when the service requested by the mobile subscriber station is the best effort service, the method further comprises the steps of:
transmitting bandwidth request information to the base station through the predetermined access channel signal;
receiving a bandwidth allocation information from the base station; and
transmitting data to the base station using the transmission bandwidth allocated from the base station.

16. A method of receiving a transmission bandwidth for data to be transmitted by a mobile subscriber station according to types of services requested by the mobile subscriber station in a broadband wireless access communication system in which a plurality of mobile subscriber stations request bandwidth allocation to a base station through a predetermined access channel signal, the method comprising the steps of:
inserting information indicating that the type of the service requested by the mobile subscriber station is an unsolicited guaranteed service in the predetermined access channel signal;
transmitting the predetermined access channel signal to the base station;
receiving a response signal to the transmitted predetermined access channel signal from the base station; and
transmitting data using the allocated transmission bandwidth when the transmission bandwidth requested by the mobile subscriber station is allocated through the response signal.

17. The method as claimed in claim 16, wherein the access channel signal transmitted from the mobile subscriber station further includes size information of the bandwidth that the mobile subscriber station desires to be allocated.

18. The method as claimed in claim 16, wherein the predetermined access channel signal transmitted from the mobile subscriber station further includes allocation interval information of the bandwidth that the mobile subscriber station desires to be allocated.

19. The method as claimed in claim 16, wherein, when the response signal includes rejection information of the service requested by the mobile subscriber station, the method further comprises the steps of:
identifying a dedicated orthogonal code included in the response signal; and
attempting fast access of a contention-free scheme to the base station using the dedicated orthogonal code.

20. The method as claimed in claim 16, wherein the mobile subscriber station is continuously and dedicatedly allocated the requested bandwidth from the base station at every predetermined allocation interval according to the request of the service.

21. A method of receiving a transmission bandwidth for data to be transmitted by a mobile subscriber station according to types of services requested by the mobile subscriber station in a broadband wireless access communication system in which a plurality of mobile subscriber stations request bandwidth allocation to a base station through a predetermined access channel signal, the method comprising the steps of:
inserting information indicating that the type of the service requested by the mobile subscriber station is a realtime packet service in the predetermined access channel signal;
transmitting the predetermined access channel signal to the base station;
receiving a response signal to the transmitted predetermined access channel signal from the base station;
creating a bandwidth request message when the response signal includes a dedicated orthogonal code;
transmitting the bandwidth request message to the base station through the dedicated orthogonal code;
receiving a requested transmission bandwidth allocated from the base station; and
transmitting data through the allocated transmission bandwidth.

22. The method as claimed in claim 21, wherein the access channel signal transmitted from the mobile subscriber station further includes transmission interval information of the bandwidth that the mobile subscriber station desires to be allocated.

23. The method as claimed in claim 21, wherein, when the response signal includes rejection information of the service requested by the mobile subscriber station, the method further comprises the steps of:
identifying the dedicated orthogonal code included in the response signal; and
attempting fast access of a contention-free scheme to the base station using the dedicated orthogonal code.

24. The method as claimed in claim 21, wherein, the mobile subscriber station repeatedly requests a bandwidth to the base station using a pre-allocated dedicated orthogonal code at every predetermined period of time only when there is a size difference between data to be transmitted in a current transmission section and data transmitted in a previous transmission section, such that the mobile subscriber station is allocated the requested bandwidth in realtime.

25. The method as claimed in claim 24, wherein information of the bandwidth request performed at every predetermined period of time includes size difference information between the data to be transmitted in the current transmission section and the data transmitted in the previous transmission section.

26. A method of receiving a transmission bandwidth for data to be transmitted by a mobile subscriber station according to types of services requested by the mobile subscriber station in a broadband wireless access communication system in which a plurality of mobile subscriber stations request bandwidth allocation to a base station through a predetermined access channel signal, the method comprising the steps of:
inserting information indicating that the type of the service requested by the mobile subscriber station is a non-realtime packet service in the predetermined access channel signal;
transmitting the predetermined access channel signal to the base station;
receiving a response signal to the transmitted predetermined access channel signal from the base station;
creating a bandwidth request message when the response signal includes a dedicated orthogonal code;
transmitting the bandwidth request message to the base station through the dedicated orthogonal code;
receiving a requested transmission bandwidth allocated from the base station; and
transmitting data through the allocated transmission bandwidth.

27. The method as claimed in claim 26, wherein the mobile subscriber station re-transmits the bandwidth request message to the base station when the response signal includes rejection information of the service requested by the mobile subscriber station.
